(19) United States
(12) Patent Application Publication
(10) Pub. No.: US 2009/0132464 A1
(43) Pub. Date: May 21, 2009

(54) Methods for processing generic chemical structure representations

(75) Inventors: Anton Fliri, Stonington, CT (US); Erwan Moysan, Les Clayes Sous Bois (FR); Pierre Benichou, Creteil (FR); Matthias Nolte, Amston, CT (US)

Correspondence Address: BUCHANAN, INGERSOLL & ROONEY PC, POST OFFICE BOX 1404, ALEXANDRIA, VA, 22313-1404, US

(73) Assignee: Decript Inc., Buffalo, NY (US)

(21) Appl. No.: 12/285,927

(22) Filed: Oct. 16, 2008

Related U.S. Application Data
(60) Provisional application No. 60/960,835, filed on Oct. 16, 2007.

(51) Int. Cl. G06F 7/00; G06F 17/30

(52) U.S. Cl. 707/1; 707/102; 707/100; 707/E17.044; 707/E17.014

(57) ABSTRACT

The invention relates to machine assisted analysis of information encoded by generic chemical structure representations, and to methods for processing these structures.

This disclosure is accompanied by a Computer Program Listing Appendix that includes a compact disk containing the files for an exemplary implementation of an enumerator. A listing of the files appears at the end of the printed specification. The contents of the Appendix are hereby incorporated by reference in this disclosure.

### FIELD OF THE INVENTION

This invention relates to methods for analyzing the content encoded by general chemical structure descriptions such as, for example, Markush structures.

### BACKGROUND

It is well known that the properties of matter, whether man made or natural, are defined by its chemical composition. Thus, it is common practice to use chemical structure representations in descriptions of property or utility information associated with compositions of matter. Chemical structures characterizing compositions of matter can be altered by changing:
1. the atom constitution of chemical structure scaffolds (genus), and/or
2. by attaching structure fragments with different properties (substituent groupings) to a common structure core.
   An efficient method has evolved for describing similar compositions of matter by using generic chemical structure representations. These general chemical structure representations can describe a near infinite number of chemical compositions, by using a compact set of text instructions for modifying the corresponding general chemical structure representations.

Methods for constructing these general chemical structure representations can be divided into two groups:

1. those that are based on the reactions and precursors used to synthesize chemical library constituents, and

2. methods that describe the structures of reaction products.

These general chemical structure representations usually consist of instructions for:

(a) attaching various substituent groups (also called R-groups) with different secondary structure elements to core scaffolds;

(b) allowing or restricting variations of the atom compositions of certain constituents of either R-group collections or generic structure cores;

(c) identification of specifying attachment points in structure fragments, and

(d) instructions for varying the composition of matter by attaching substituent groupings to these attachment points in a combinatorial manner.

Since the purpose of chemical composition of matter patents is to disclose information on the utilities associated with compositions having a particular chemical structure design and to prevent others from making using or selling products with the same or similar molecular architecture, these general chemical structure representations are also frequently used for claiming compositions of matter and/or their utility. See, e.g., Markush E. A., U.S. Pat. No. 1,506,316.

Based on the case law, the term “Markush structure” is frequently used for chemical structure representations describing the content of claims in composition of matter patent applications. The term “Markush structure” is frequently also used for describing generic chemical structure representations defining the content of combinatorial chemical libraries and the contents of libraries containing collections of proteins, carbohydrate, DNA and RNA sequences. However there are fundamental differences between these two concepts.

For example, the content of combinatorial libraries and the contents of libraries containing collections of proteins, carbohydrate, DNA and RNA sequences encoded by generic chemical structure representations can be approximated by

1. selecting a random combination of structure fragments (substituent groups) and

2. by randomly attaching these structure fragments at various attachment points of a common structure core.

Using this “Chemical Structure Space” filling strategy enables these random enumeration processes to create a homogenous distribution of matter around a common structure core.

In contrast, Markush structure definitions in patent claims reflect the knowledge associated with specific structure property relationship and therefore claims define an inhomogeneous distribution of matter in chemical structure space. Thus while two inventions may share common structure cores, the claims in these different patents may specify the production of entirely different molecules and produce a non-overlapping distribution of matter in chemical structure space. Accordingly, inventors may be entitled to a patent for particular compositions of matter despite the fact that two different inventions operate in the same section of the Markush structure space. This situation is created if the claims in different patent applications are drafted in such a way that non-overlapping composition of matter can be created. Detecting if the claim language in different patents produces overlapping inventions is one of the key objectives in chemical patent examination.

Accordingly, the examination of composition of matter patent applications devotes a great deal of effort for identifying and examining patents with similar Markush structure contents. The same is true for inventors and applicants for patent applications which need to examine if issued patents provide enough freedom to claim non-overlapping compositions. Since the likelihood that a new application describes matter that encroaches on already patented chemical structure space is highest for compositions of matter exhibiting similar Markush structure cores, machine methods have been developed for identifying prior art documents that exhibit similar Markush structure cores. Currently two machine readable data sources are available for conducting these prior art Markush structure searches: One of them is the Marpat database (see, e.g., U.S. Pat. No. 4,642,762) and the other is the MMS database as described in EPO451049. It is not uncommon that Markush structure similarity searches conducted in these two databases identify hundreds of documents. Since the scope of intellectual property is defined by the Markush structure claims in each of these documents, determining if any one of the Markush structures claim in these prior art document collections defines chemical structure space that overlaps with a new invention requires the examination of hundreds of documents. Since no machine methods are available for this examination, each Markush structure in each document needs to be scrutinized manually and this process is currently entirely based on mental enumeration. The term “enumeration” hereinafter used refers to a process for constructing individual chemical structures (compounds) based on the known chemical bonding principles for connecting structure fragments defined in the Markush structure patent claims.

With reference to FIG. 1, it is common practice to start such enumeration processes by identifying the precise molecular structure of a specific genus in accordance with the Markush structure claim definitions and by rendering this selection enumerable by identifying attachment points specified in the claim language for connecting substituent groupings in accordance with the patent claim definitions. In this context the term “enumerable structure fragments” refers to a collection of building blocks that have discrete chemical architectures and discrete attachment points. Likewise, the term “enumeration readied structure fragments” refers to a collection of building blocks that have been rendered enumerable by assigning to each building block a discrete chemical architecture and discrete attachment points. Depending on the number of attachment points in a given genus, this process usually yields a multiplicity of starting points each having a discrete molecular architecture. In this context the term enumerable structure fragments refers to a collection of building blocks that have discrete chemical architectures and discrete attachment points. Discrete species (single compounds) can then be created from any one of these starting points by successively attaching fragments with specific molecular topology in accordance with the claim language. This process is repeated for each attachment point until all the conditions defined by a patent's claim language are exhausted (See e.g., John M. Barnard, Geoff M. Downs, Annette von Scholley-Pfab and Robert D. Brown Journal of Molecular Graphics and Modeling, Volume 18, Issues 4-5, 2000, Pages 452-463).

However, no matter how much time is devoted to this process, all of these mental enumeration processes are incomplete and subjective because generic chemical structure descriptions generally can encode a near infinite number of compositions. Thus, because of this open-ended nature, it becomes impossible to list the near infinite number of possible enumeration products for hundreds of examined patent documents.

Accordingly, all known methods for analyzing the content encoded by Markush structures rely on partial enumeration. (Anton Fliri, Discovery Knowledge & Informatics 2007, Presentation Apr. 24, 2007; Szabolcs Csepregi, et. al. UGM 2007 Presentations, Jun. 21, 2007).

A further limitation of manual patent examination arises due to the complexity of Markush structure definitions in patent claims. Moreover, because there are no standards for defining the nomenclature for Markush structure definitions in patent claims; the comparison of documents of different origins requires translation of the terminology that is used in different documents into common formats. This translation step requires expert knowledge because the determination of structural equivalencies between different terminologies requires assessment of topological relationships between different Markush structures. This evaluation is further complicated because this analysis may encounter open-ended and indefinite terminology for describing collections of chemical structure fragments with similar physicochemical properties. For example, the generic term “alkyl” is frequently used to describe an infinite number of arrangements between an infinite number of carbon atoms each bearing potentially four different flavors of chain lengths and carbon atom arrangements. Likewise the generic term “heteroaryl” is used to encode a near infinite number of aromatic carbon based ring systems each containing one or more hetero atoms. (See e.g., Burton A. Leland et. al. J. Chem. Inf. Comput. Sci.; Volume 3, Issue, 1997, pages 62-70). Adding to the complexity of these chemical topology descriptions, the claim text in patents frequently restricts the scope of these indefinite terminologies in a non-standardized way by defining discrete subsets of these terminologies. The definitions of these subsets, in turn, may be influenced by an inventor's motive to identify specific structure property relationship in the claim language or reflect requirements imposed by patent examiners. In this respect, the precise identification of these open ended and indefinite definitions may take on the form of an independent Markush structure analysis.

Because of the complexities involved, the identification and comparison of chemical matter defined by different Markush structure claims represents one of the most resource-consuming activities of chemical patent examination. Equally complex and time consuming is the analysis of the freedom to operate and the interpretation of structure function information encoded by general chemical structure representations. Moreover, since the production of mental enumeration results is a tiring, time consuming and error prone process, it is well recognized that mistakes made during the examination of chemical composition of matter patents affect the quality and value of the claimed intellectual property.

Thus, despite the immense value of the intellectual property encoded in the form of Markush structures, access to this information is currently limited. Making matters worse, modern manufacturing methods and processes rapidly increase the volume of new information encoded by generic chemical structure representations. Accordingly, there is a need for developing machine methods that could assist in Markush structure claim analysis.

Since the current processes employed for this purpose are based on the result of mental enumeration, machine methods enabling Markush structure enumeration would reduce the uncertainty associated with mental analysis of Markush structure claims and hence decrease the concomitant risk of patent litigation. Likewise, methods that create machine processable renderings of Markush structure descriptions in different patent documents would reduce the time of the comparison of Markush structure claim descriptions in different documents. Moreover, machine methods for enumerating Markush structures would be useful for identifying and comparing the distribution characteristics of compositions of Markush structures defined by patent claims, and hence make patent examination more precise. Moreover, methods for enumerating Markush structures would also be useful for crafting the claim language in new patent applications. Likewise, methods for enumerating Markush structures would also be useful for any person desiring thorough analysis of the freedom to operate. In addition, methods for enumerating Markush structures would also be useful for identifying structure function information encoded in generic chemical structure representations such as combinatorial libraries. Finally, methods for rendering the indefinite and open-ended semantic terminologies in Markush structure text instructions into machine readable forms can be used not only for enumerating general chemical structure representations, but also provide machine processable standards that enable the comparison of the contents of general chemical structure representations. The term content in this respect refers to the sum of all of the individual chemical structures that could be made following the descriptions and text instructions associated with general chemical structure descriptions.

### BRIEF DESCRIPTION OF THE DRAWINGS

FIG. 1 is a schematic representation of a general chemical structure representation;

FIG. 2 is an exemplary flow diagram for coupling the functions of various basic methods for examining content similarity relationships between Markush structures;

FIG. 3 is an illustrative representation of a fingerprint similarity determination obtained, for example, by using a hierarchical classifier for sorting chemical structure fingerprints which were derived from the enumeration results of Markush structure renderings;

FIG. 4 is an illustrative representation of a fingerprint similarity determination obtained with a hierarchical classifier showing the comparison of chemical structure fingerprints of enumerated species derived from multiple Markush structure claims; and

FIGS. 5a-5m show examples of libraries containing enumerable Markush structure topology descriptors (structure fragments libraries) used for translating Markush structure topology information such as for example the MKST topology information that is used in the MMS data base into enumerable form.

FIGS. 6a and 6b illustrate an example of a descriptor as rendered by the definer.

FIG. 7 illustrates examples of substituent fragment technology descriptors that are generated for an open-ended term.

FIGS. 8a and 8b illustrate examples of user-generated claim rules for enumerating a commercially available database.

FIGS. 9a-9n illustrate examples of structure fragment libraries for translating a semantic term into enumerable form.

FIG. 10 shows an example of an enumeration rule created by associating a specific structure fragment with the Markush structure topology information defined by the Markush structure appearing, for example, in patent WO 218333.

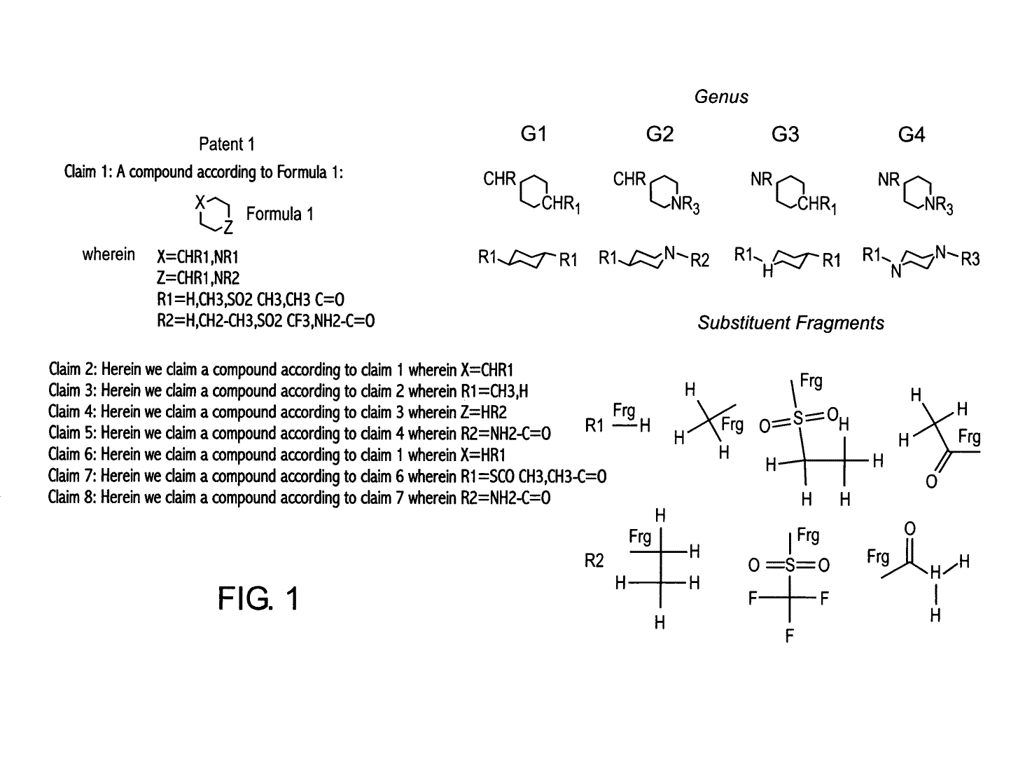

### DETAILED DESCRIPTION

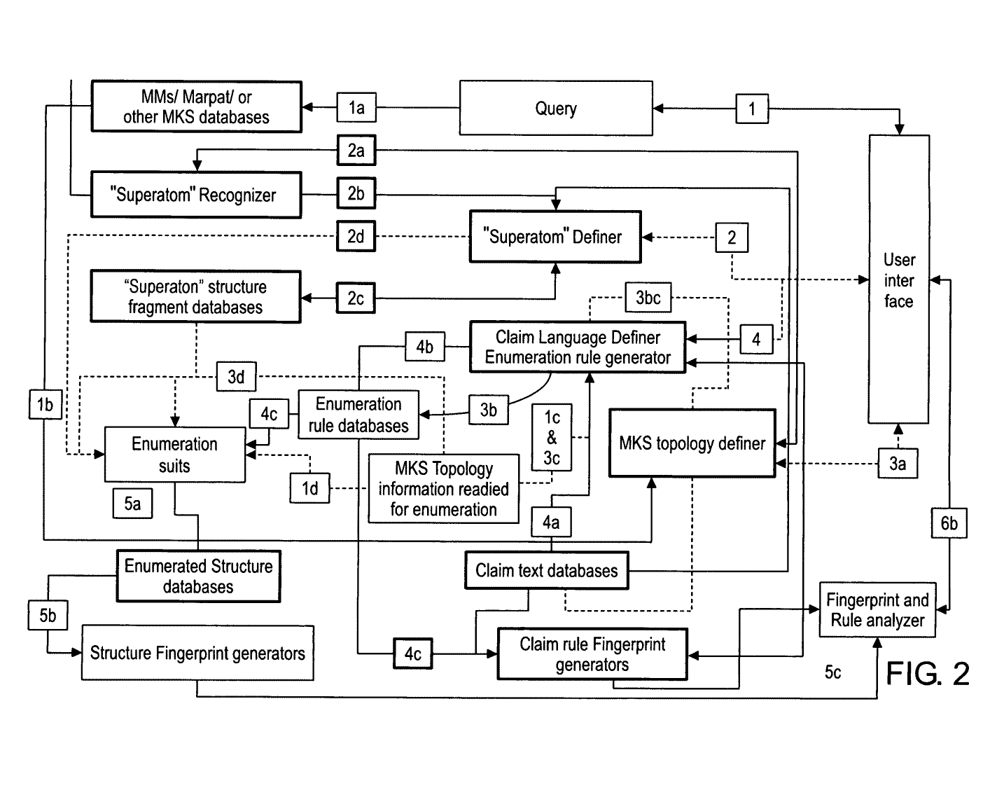

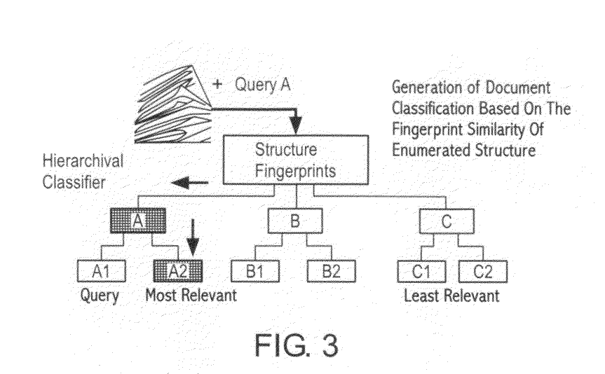

FIG. 2 illustrates a general schema comprising processes numbered 1-6 for examining structure utility relationship information encoded by Markush structure descriptions in chemical composition of matter patents and in general chemical structure representations capturing structure function information. In one aspect of the invention, the application of processes 2,3,4 and 6 can be used to create comparable renderings of Markush structure topology information and Markush structure claim information of documents with different origins. These renderings can be used by processes that enable the content analysis of Markush structures such as for example in the analysis of patent search results, the examination of patent documents, processes for determining the freedom to operate and the determination and comparison of molecular properties associated with chemical structures described by different Markush structures. An illustration of this sorting aspect of the invention is shown in FIG. 3.

Since these renderings create machine readable renderings of Markush structure representations from different documents, these processes are useful for the machine-assisted translation of different semantic expressions of Markush structure claims into common formats.

Another aspect of the invention provided by process 5 of the general schema is the reduction of uncertainties associated with the outcome of mental analysis of complex Markush structure information by exacting, through claim specific Markush structure enumeration, the determination of the scope of Markush structure claims in patent applications. Thus, this aspect of the invention has implicit utility for determining risks associated with patent litigation and utility for estimating the value of intellectual property.

A further aspect of the invention provided by process 6 of the general schema is utility in data mining applications through the extraction of structure property relationship information encoded in Markush structure representations which, for example, may involve calculation of molecular properties associated with enumerated species and the identification of structure property similarity relationships.

Yet another aspect of the invention provided by process 2 of the general schema is the ability to render generic, indefinite and open-ended terminology that is used in formulating Markush structure claim descriptions in documents and in the MMS and Marpat databases into machine readable form. Accordingly, the invention has utility for creating chemical structure fragment topology descriptors and databases containing these structure fragment collections, and implicitly has also utility in processes for enumerating general chemical structure representations.

Another aspect of the invention pertains the use of processes 5b and 4c in effecting analysis of complex structure utility and structure property relationships through the creation of characteristic fingerprints of the text and chemical structure fragment based instructions that are used in the construction of Markush structure claims in chemical composition of matter patent claims, or general chemical structure representations describing general structure function observations in documents. Process 5b of the general schema effects the comparison of information associated with enumerated species by using fingerprints of structure fragments and fingerprints of text mining derived information, such as information associated with claim origin, properties or utilities of claimed inventions, expressed as co-invention frequencies of utilities in compositions of matter patents. Hence, process 5b has utility for determining associations between utilities and chemical structure designs in certain technology areas. Therefore, the invention has utility for characterizing landscapes and scopes of innovations disclosed in patent documents.

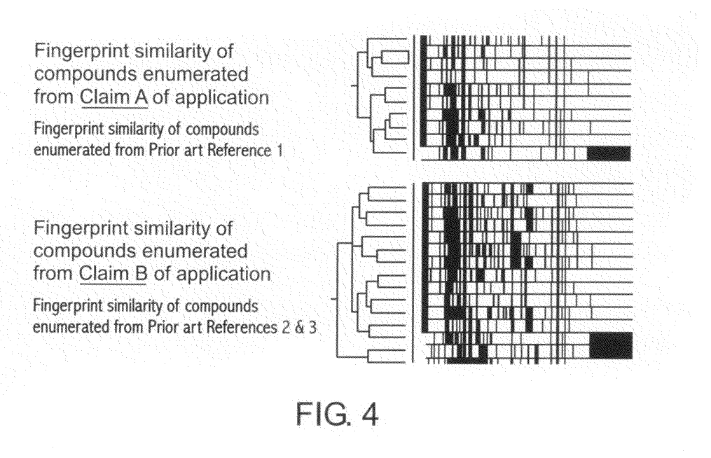

A further aspect of process 6 of the general schema is its utility for effecting the comparison of structure fragment fingerprints of enumerated species with structure fragment fingerprints specified by the claim text of different patent documents. This aspect enables the simultaneous consideration of a broad spectrum of claim relationships defined by a plurality of Markush structures. This aspect of the invention is depicted in FIG. 4. This figure illustrates a clustering dendrogram with a hierarchical clustering of enumerated structure fingerprints that originate from different Markush structures in different patents, and the translation of the structure similarity relationship of species associated with different patent claims into a common format. From this format, multiple claims from different references can be compared with one another.

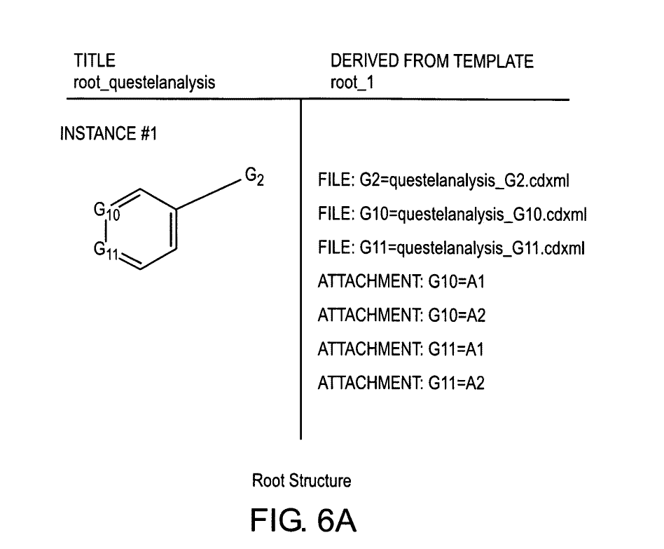

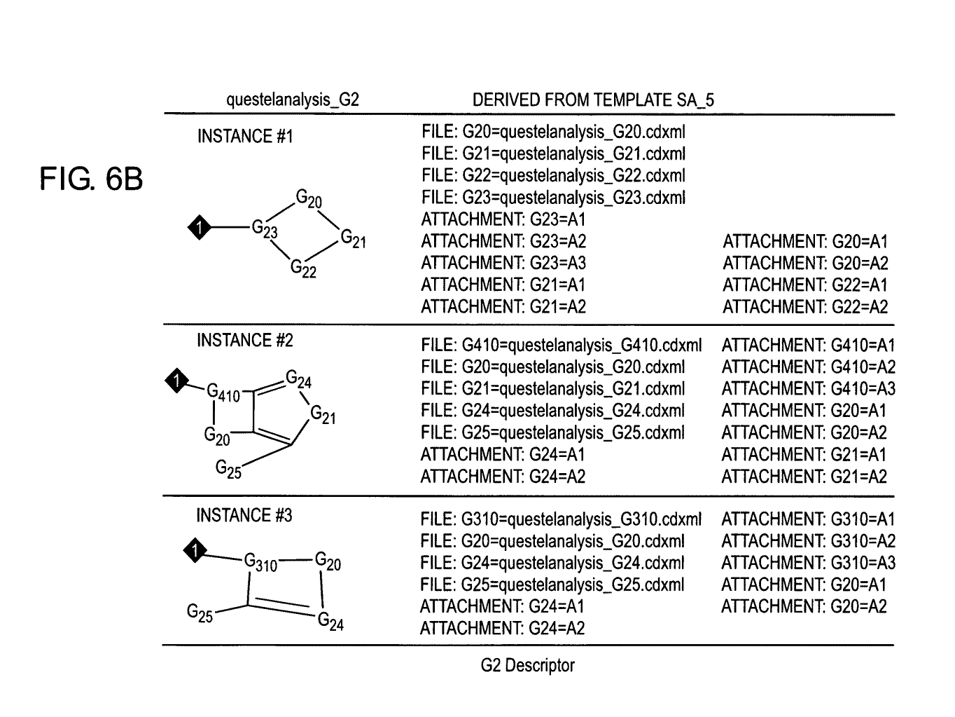

Accordingly, the invention has utility in comparative analysis of patent claims defining compositions of matter in various areas of innovation. The general schema comprises of a combination of processes 1-6. Process 1 consists of a combination of steps 1a-1d, to generate and store Markush structure descriptors. Step 1a of the general schema effects the sending of Markush structure related search results, originating from either structure or text queries entered via a user interface, to Markus structure databases containing Markush structure topology information for search results, such as, for example, the MMS or Marpat Markush structure databases, or equivalents thereof. Step 1b of the general schema effects the importing of the Markush structure topology information from the Markush structure databases into a Markush structure topology definer. The Markush structure topology definer effects the rendering of the Markush structure topology information into enumerable Markush structure topology descriptors. An example of such descriptors is illustrated in FIGS. 6a and 6b. Step 1c of the general schema effects the importing of the enumerable Markush structure topology descriptors into an intermittent database. The intermittent database effects the storing, retrieving and processing of the enumerable Markush structure topology descriptors. Step 1d of the general schema effects the importing of the enumerable Markush structure topology descriptors into a “Markush Structure Enumerator”.

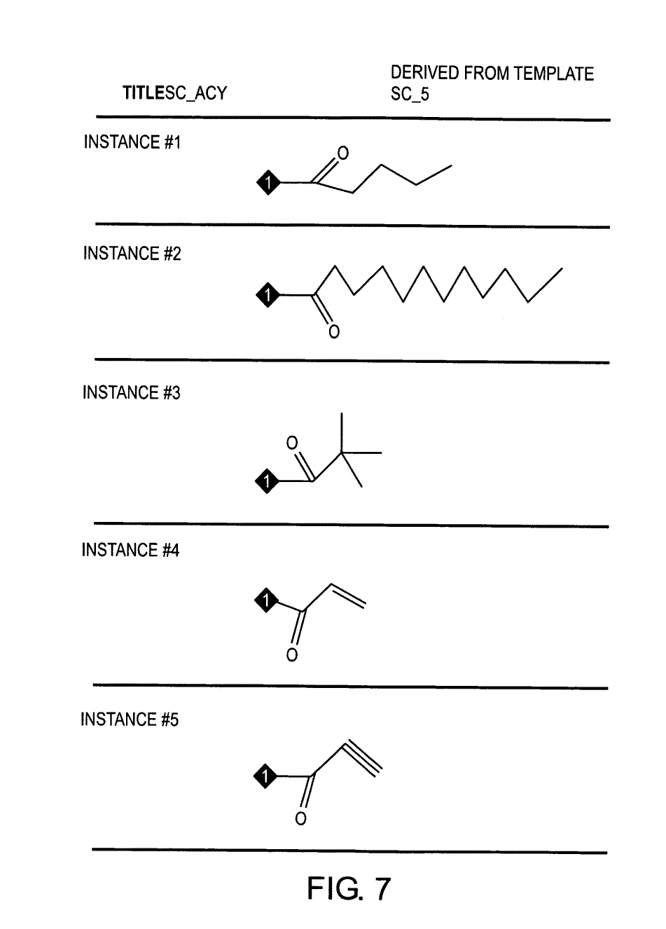

Process 2 of the general schema consists of a combination of steps 2a-d, to create and store substituent fragment topology descriptors. Step 2a effects the recognition of generic, indefinite and open-ended terminology of substituent definitions that have been imported either by a Markush structure topology definer from a Markush structure database, such as, for example, the “MMS” or “Marpat” Markush structure databases. In the alternative, step 2a may also effect the recognition of generic, indefinite and open-ended terminology found in the claim text of patent documents, in the claim text of patent applications and in user rendered descriptions of general chemical structure descriptions. Step 2b of the general schema constitutes a “superatom definer” for effecting the automatic or the user guided rendering of the generic, open-ended and indefinite terminologies into enumerable substituent fragment topology descriptors. This is done by replacing the generic, open-ended and indefinite substituent definitions with a list of substituent fragment topology descriptors consisting of structure fragments described in prior art patent applications within the scope of the generic, open-ended and indefinite substituent definitions, or within the scope of composition of matter inventions considered for analysis by a user. FIG. 7 illustrates an example of substituent fragment topology descriptors in which the open-ended term “acyl” is replaced by structure fragments with discrete chemical architectures and discrete attachment points. In this example, the first three descriptor instances comprise alkyls, the fourth instance is an alkenyl, and the fifth instance is an alkynyl.

Step 2c of the general schema effects the exporting of the substituent fragment topology descriptors into one or multiple databases effecting the storing, retrieving and processing of the structure fragment topology descriptors. Step 2d of the general schema effects the importing of the substituent structure fragment topology descriptors from the databases by Markush Structure Enumerators.

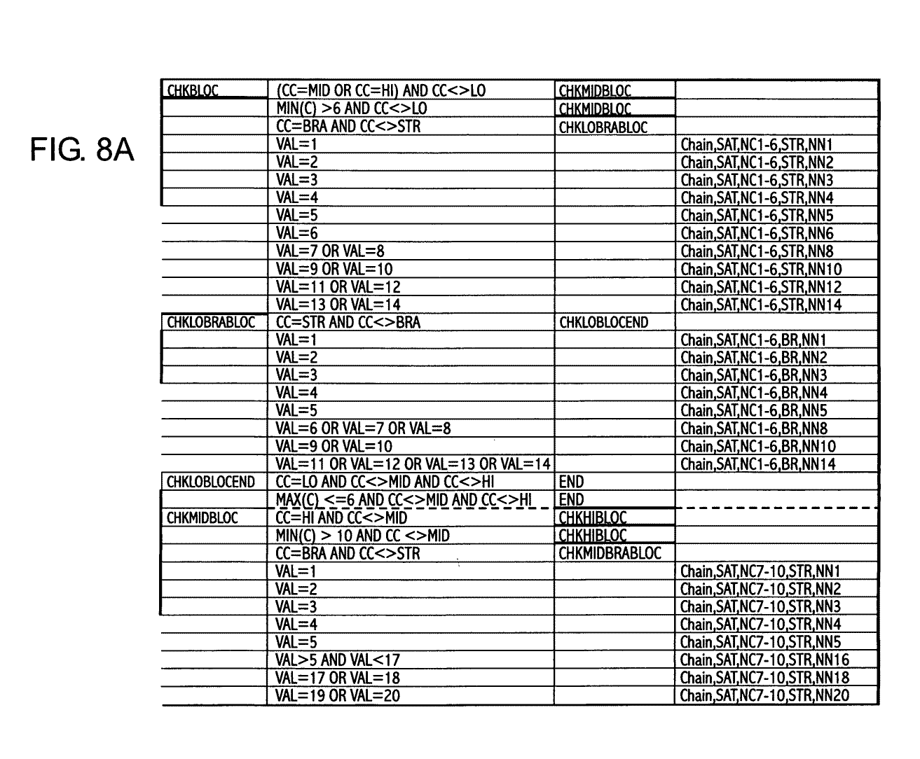

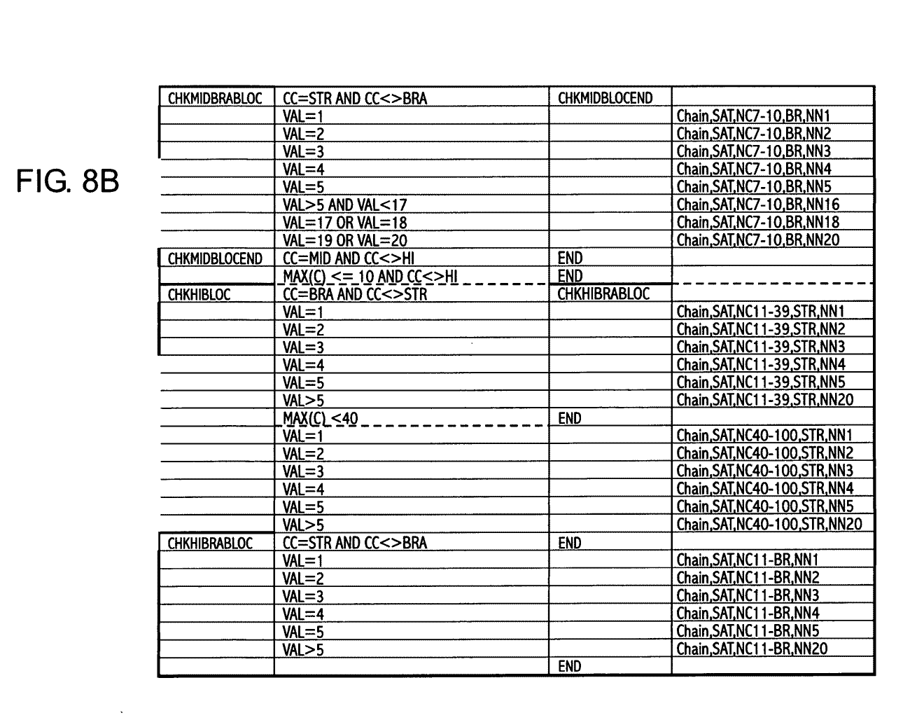

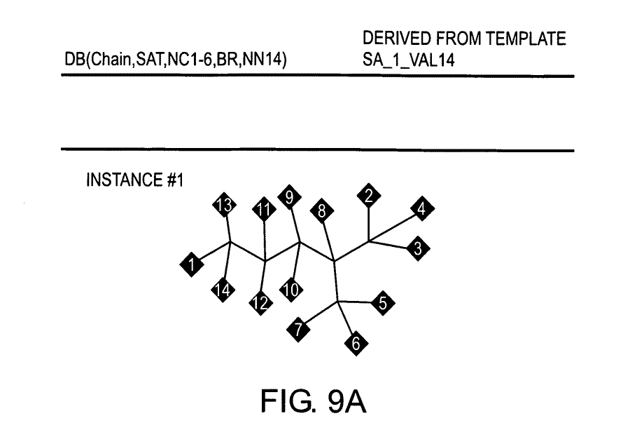

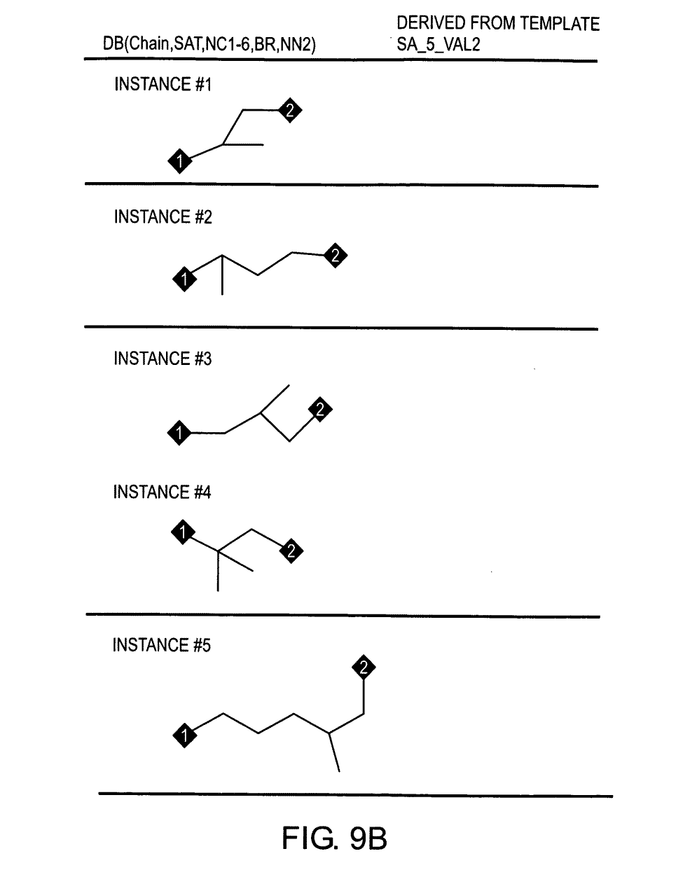

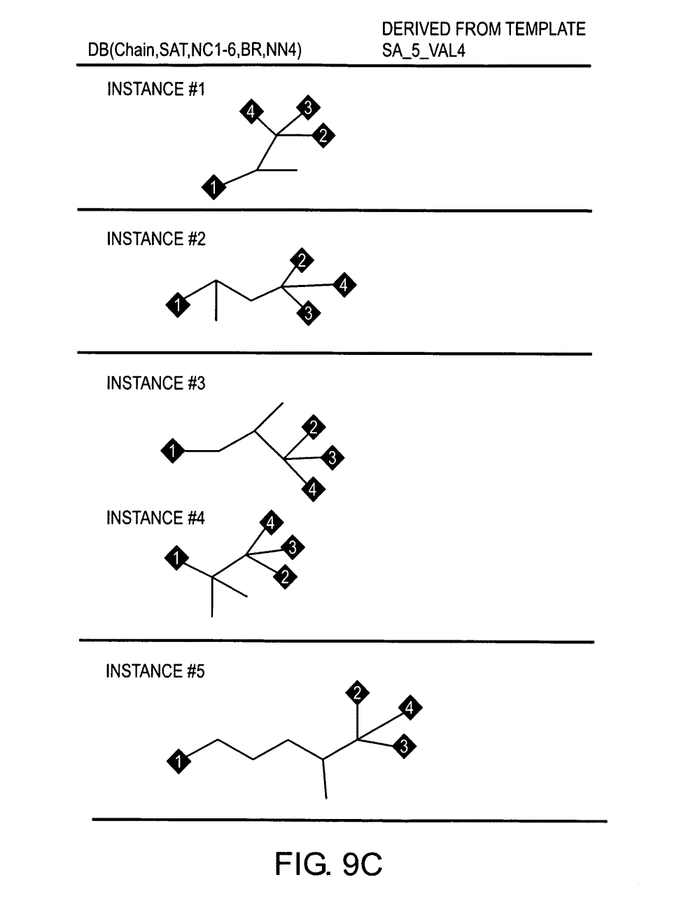

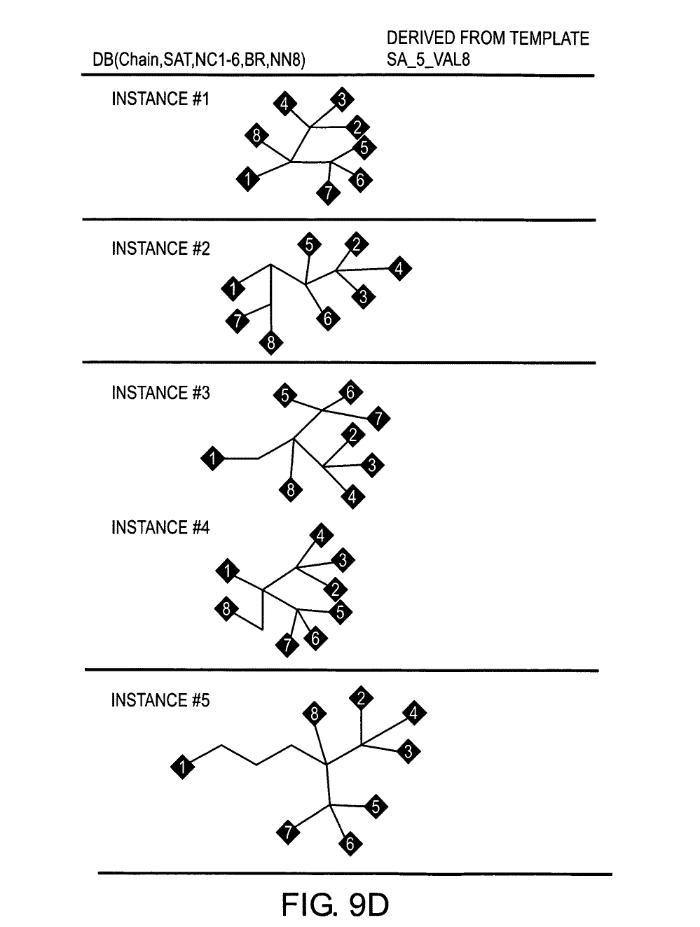

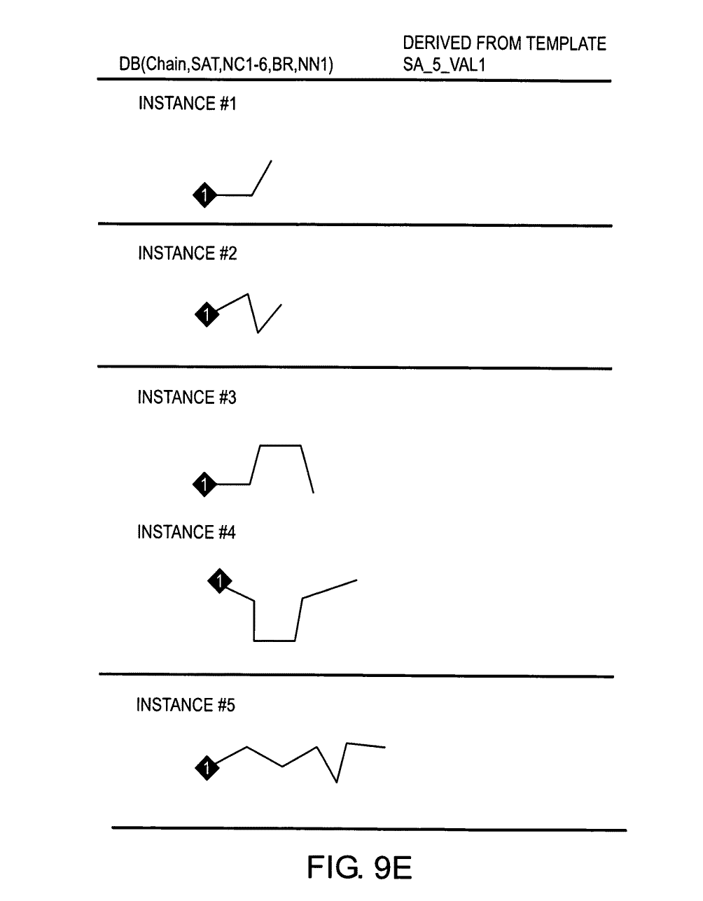

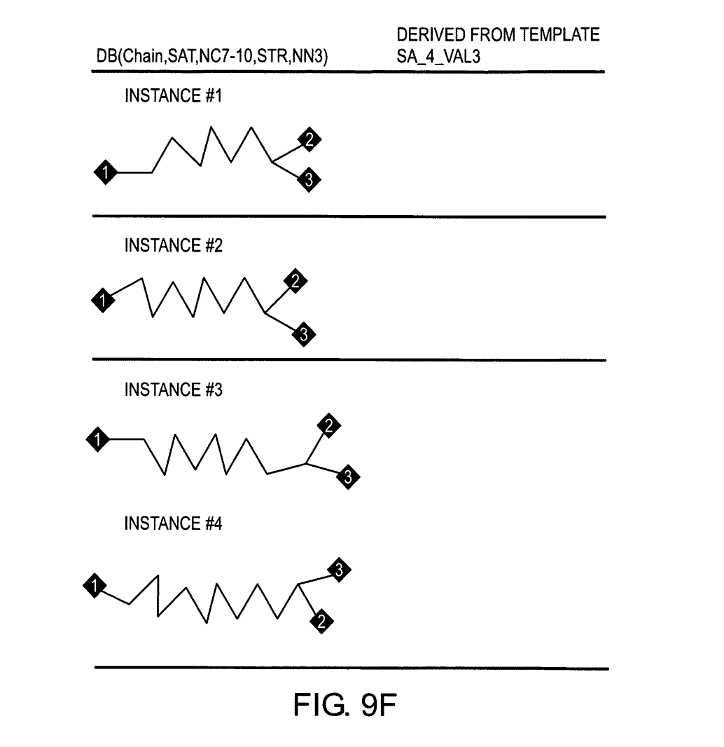

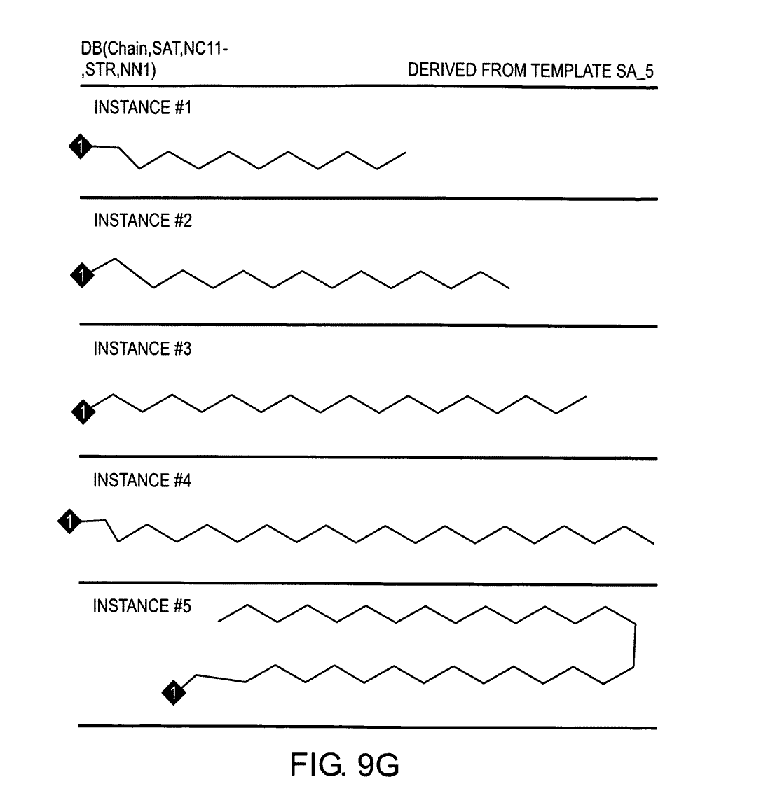

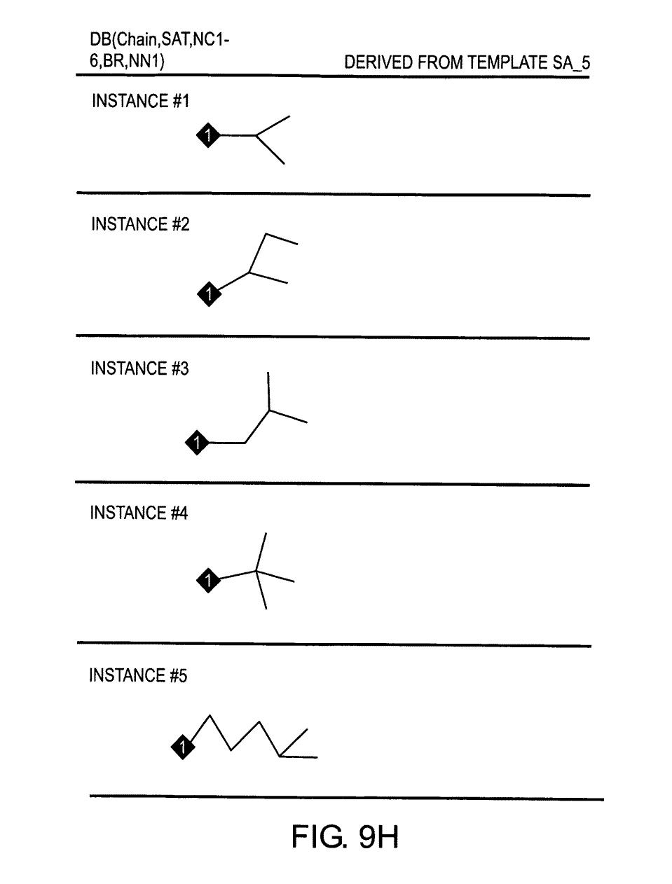

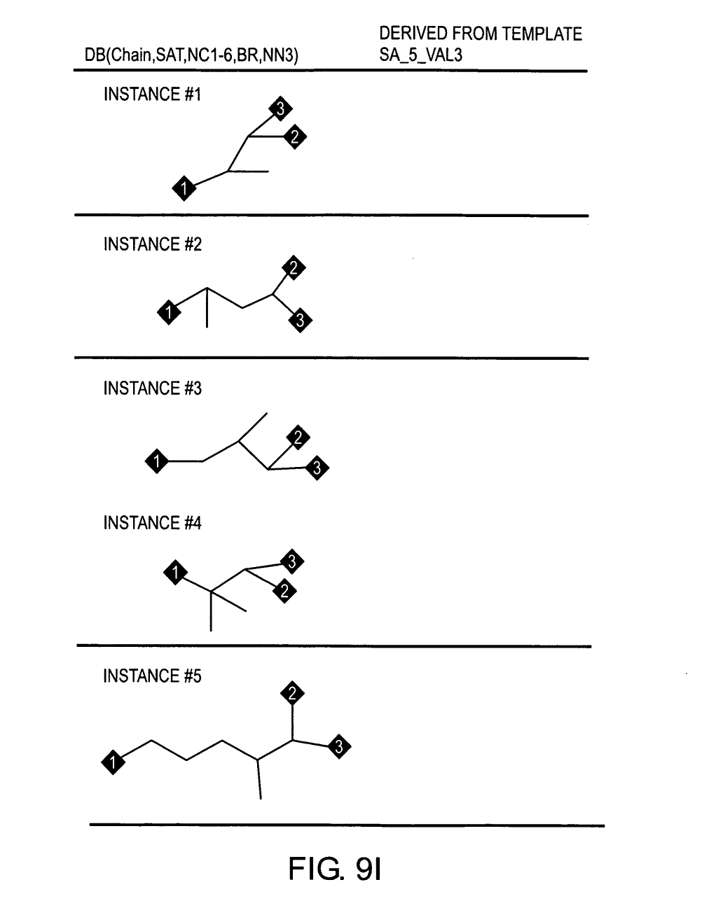

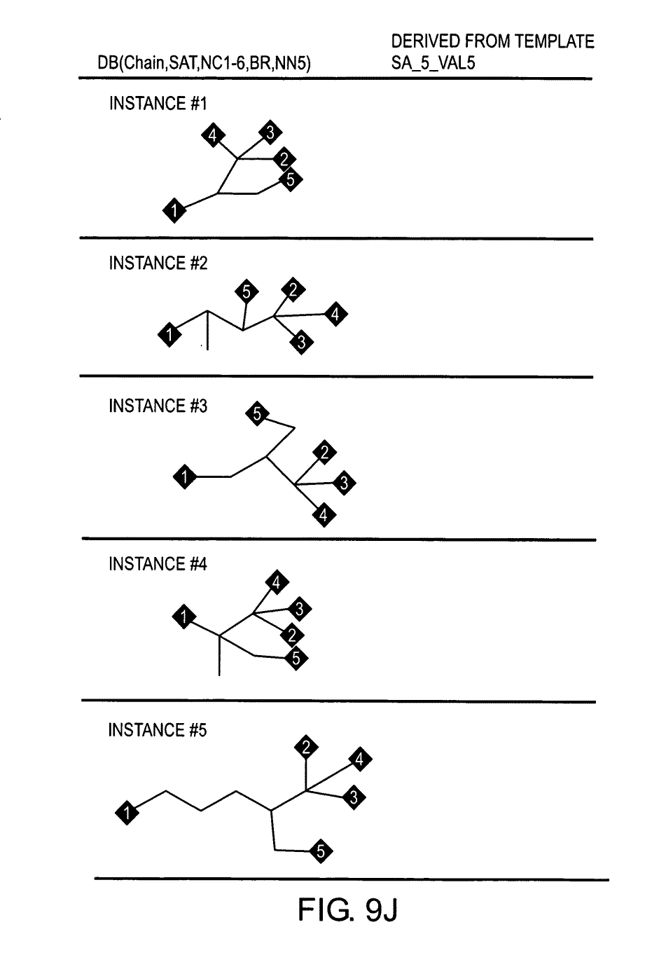

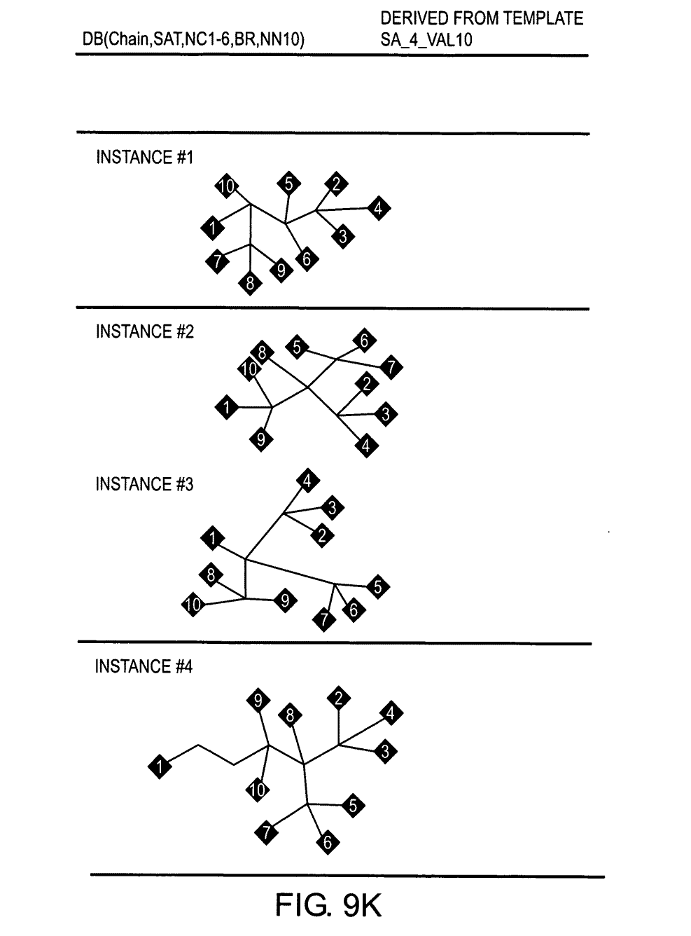

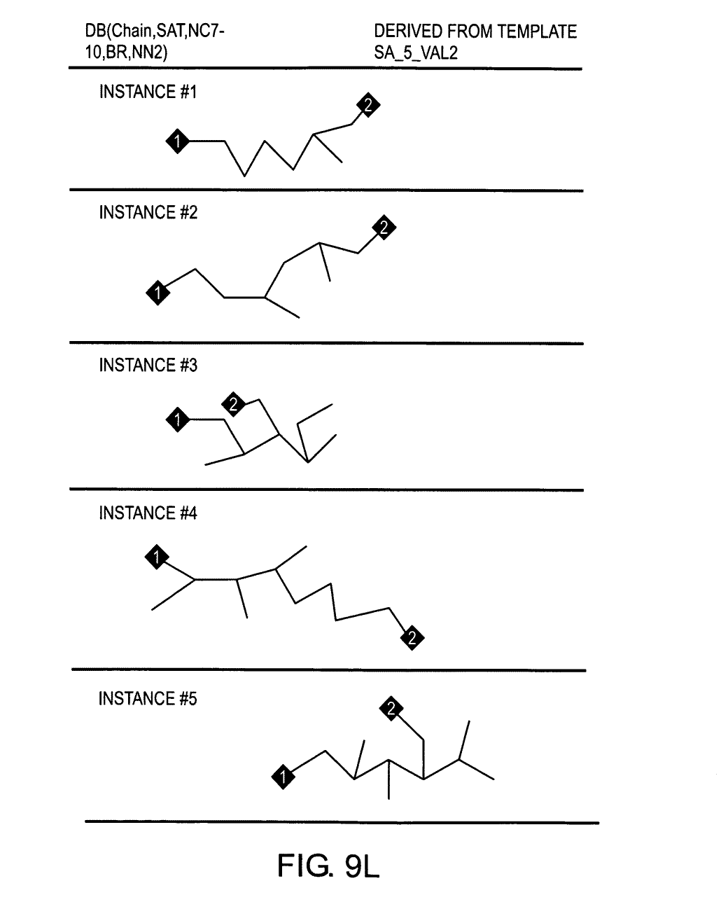

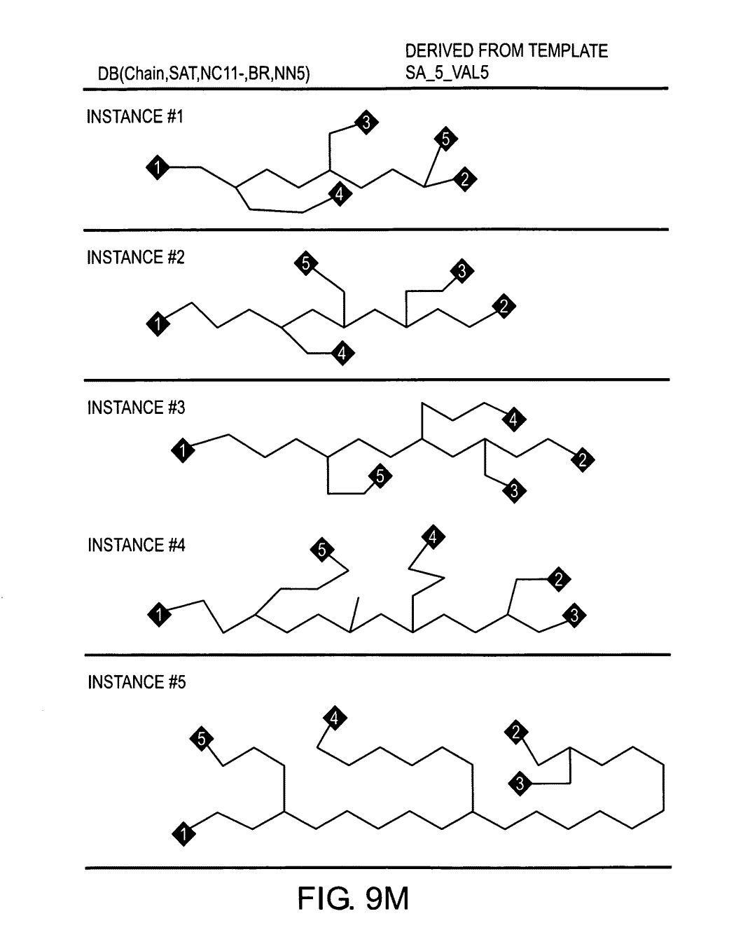

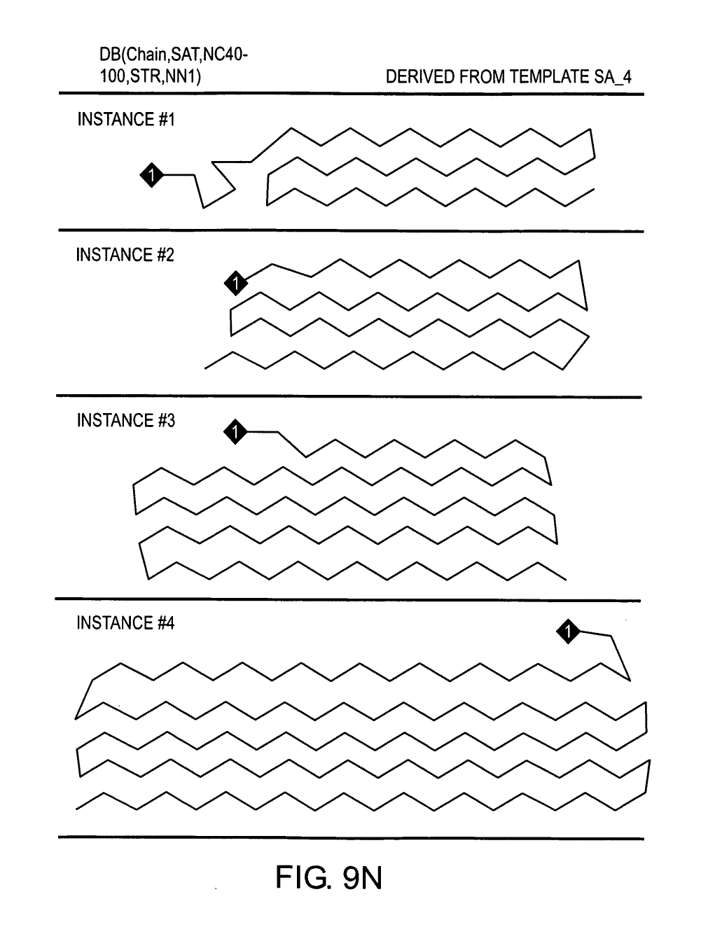

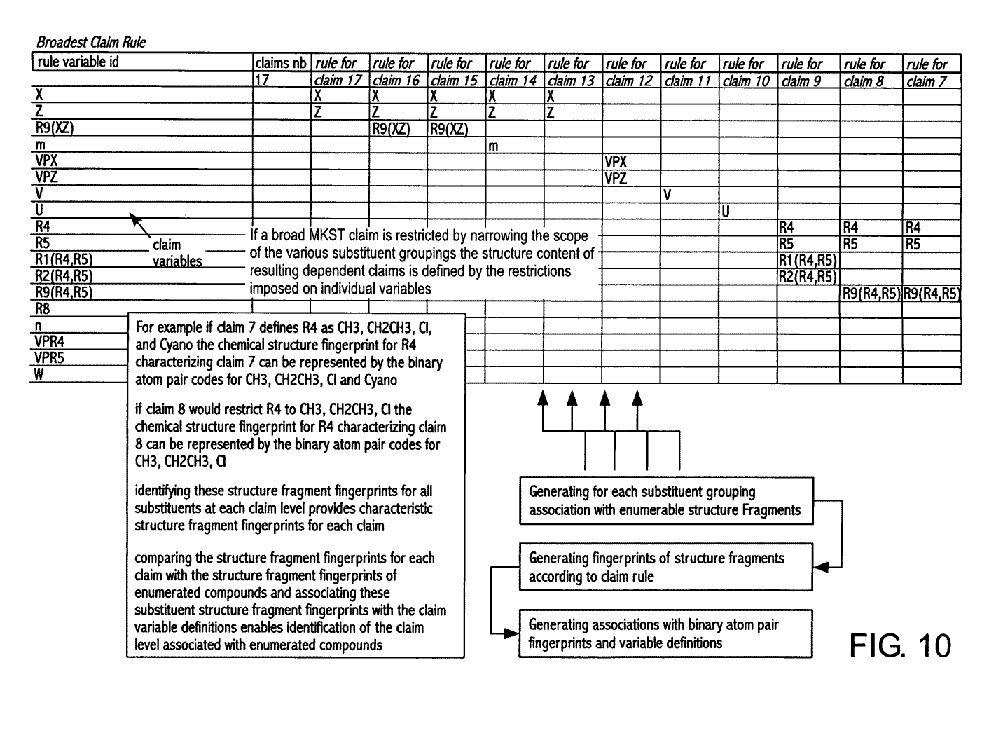

Process 3 of the general schema consists of a third combination of steps 3a-d, for user-guided creation and storage of enumeration-ready topology descriptors. Step 3a effects the rendering of general chemical structure topology descriptions in enumeration-readied form by using commercially available software enabling the drawing of chemical structure representations, such as for example Chemdraw, Isis or Marvin. Step 3a provides also an alternative for creating the renderings by importing Markush structure topology information from the MMS or Marpat databases and by translating the imported Markush structure topology information into enumeration-ready form by creating Markush structure topology descriptors using either machine-aided translation processes or user guided means, such as, for example Chemdraw, MDL derived tools, STN, DARC, the KMS indexing station or Marvin. Step 3b of the general schema effects the generation of enumeration rules by creating associations between enumeration-ready topology descriptors and Markush structure text information. For example, user guided associations can be created between specific Markush structure core topology descriptors (genus). User-guided associations can also be created between attachment points in the core Markush structure topology descriptors and the topology descriptors of substituent groupings according to the text of chemical composition of matter patent claims. FIGS. 8a and 8b illustrate examples of user-generated claim rules for enumerating the MMS database. FIGS. 9a-9n illustrate examples of structure fragment libraries for translating the semantic term “alkyl” that might appear in patent claims, and the corresponding semantic term “CHK” in the MMS database, into enumerable form. Step 3b effects the exporting of the enumeration rules to an enumeration rule database. Step 3c effects the exporting of enumeration-ready Markush structure topology descriptors into Markush structure topology descriptor databases. Step 3d effects the importing of the enumeration-readied topology descriptors into Markush Structure Enumerators.

Process 4 of the general schema consists of a combination of steps 4a-b, for the creation and storage of claim rule fingerprints. Step 4a of the general schema consists of processes for the automated construction of “enumeration rules” by effecting the identification of core Markush structure topology descriptors (genus), the identification attachment points of core Markush structure topology descriptors and the identification of combinations of substituent structure fragment descriptors on the attachment points, using machine readable renderings of text instructions provided by structure function information associated with generic chemical structure representations or by the patent claims in chemical composition of matter patents. Step 4b of the general schema effects the storing and retrieving of the enumeration rules in enumeration rule databases. Step 4c of the general schema effects the generation of structure fragment topology fingerprints of the enumeration rules and the storing of the structure fragment topology fingerprints in claim rule fingerprint databases. An example of a fingerprint is illustrated in FIG. 6. Step 4d of the general schema effects the readying of the claim rule fingerprints for fingerprint analysis and the exporting of the claim rule fingerprints to a fingerprint analyzer. The readying of the claim rule fingerprints may involve standardization of fingerprints which, in turn, may require the identification of semantic equivalencies between terminologies of use in patent claims and the translation of different semantic terminologies in to a standard terminology. See, for example, methods such as those described by Fliri et al in Chem Med Chem 2007; 2(12):1774-82. Step 4e of the general schema effects the importing of the enumeration rules from the enumeration rule database into a Markush Structure Enumerator.

Process 5 of the general schema consists of a combination of steps 5a-b to create and name individual species. Step 5a of the general schema effects the importing of the enumeration-readied Markush structure topology descriptors from the database records produced by steps 1d and 3d into a Markush structure enumerator. It also effects the importing of substituent structure fragment topology descriptors resulting from step 2d and the importing of enumeration rules resulting from step 4e. Step 5a further includes a method for iteratively attaching the enumeration-readied Markush structure topology descriptors to the substituent structure fragment topology descriptors using a random selection of substituent groupings in a manner defined by the enumeration rules. Step 5b of the general schema effects the assignment of registration codes to enumerated species and the association of the registration numbers with the enumeration rule information yielding the species, the topology descriptors defining the chemical structures and the information defining the origin of the Markush structure descriptors yielding the enumerated species. Step 5b further includes a method for exporting the associated information into an enumerated compound database. Step 5b also effects the creation of chemical structure topology fingerprints of enumerated species in the enumerated compound database. This feature comprises a method for associating the structure topology fingerprints of a species and the enumeration rules yielding that species with the information defining the origin of the Markush structure claiming the species. The associated information is stored in a database, for fingerprint analysis.

The Computer Program Listing Appendix that accompanies this disclosure contains program files for a Java implementation of an one embodiment of an enumerator that performs the foregoing procedures.

Process 6 consists of a combination of steps 6a-b to identify the relationships between enumerated structures and render the results for viewing. Step 6a of the general schema effects the importing of structure topology fingerprints from the database into a fingerprint and rule analyzer, and the importing of enumeration rule fingerprints readied for fingerprint analysis. Step 6a also comprises a method for identifying fingerprint similarities such as for example methods for fingerprint profile comparison or the hierarchical clustering of fingerprints using commercially available clustering algorithms, such as Wards method or UPGMA, in combination with commercially available data analysis platforms such as, for example, Spotfire. Step 6b effects the rendering of results derived from fingerprint similarity relationship analysis for visual display at the user interface or made accessible to the end-user using other reporting instruments.

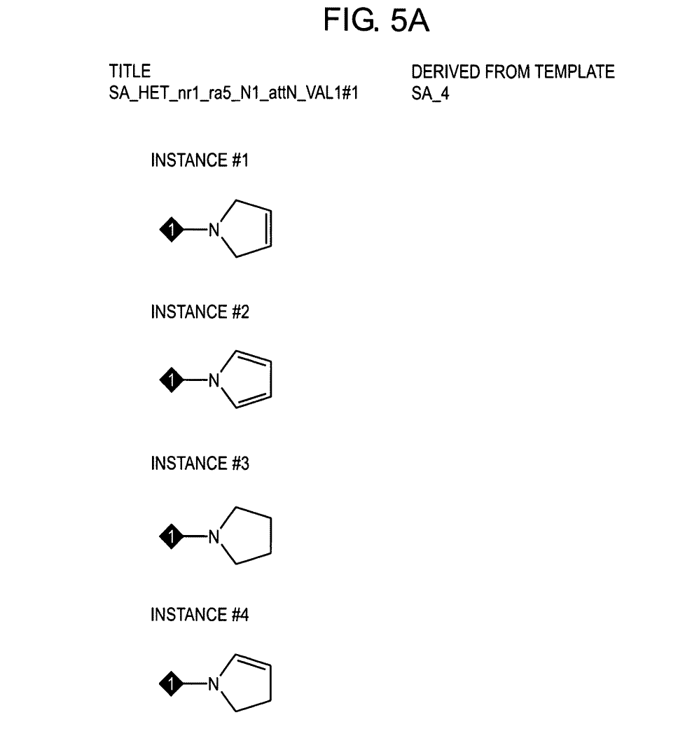

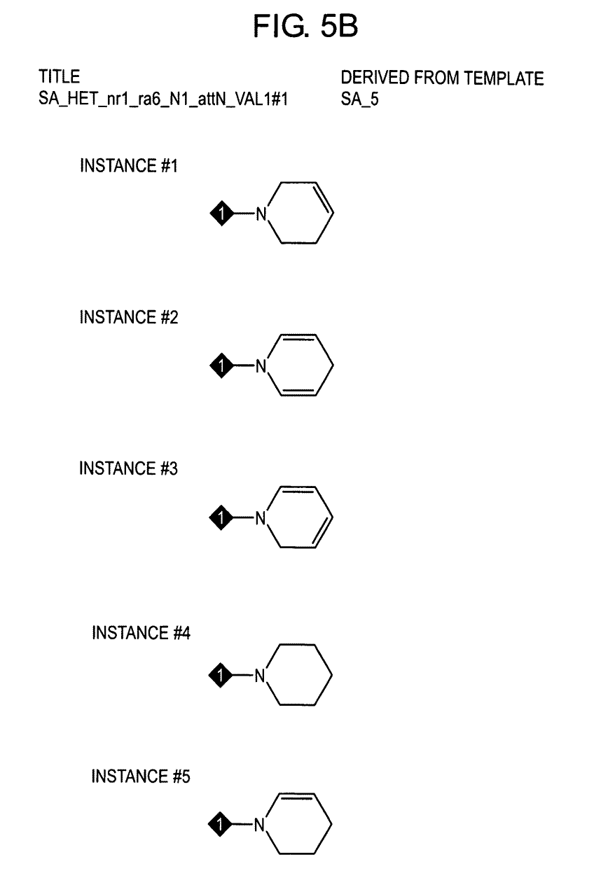

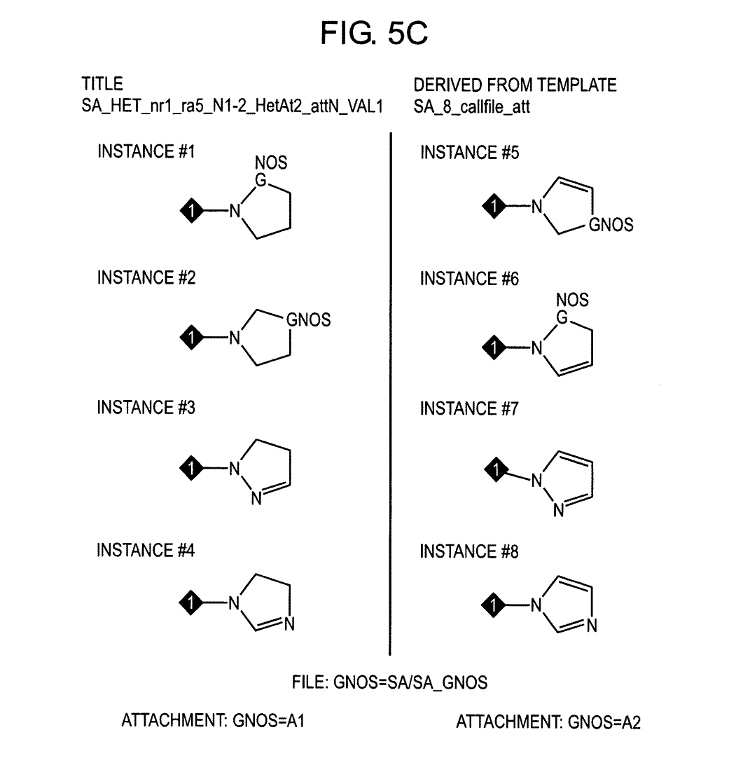

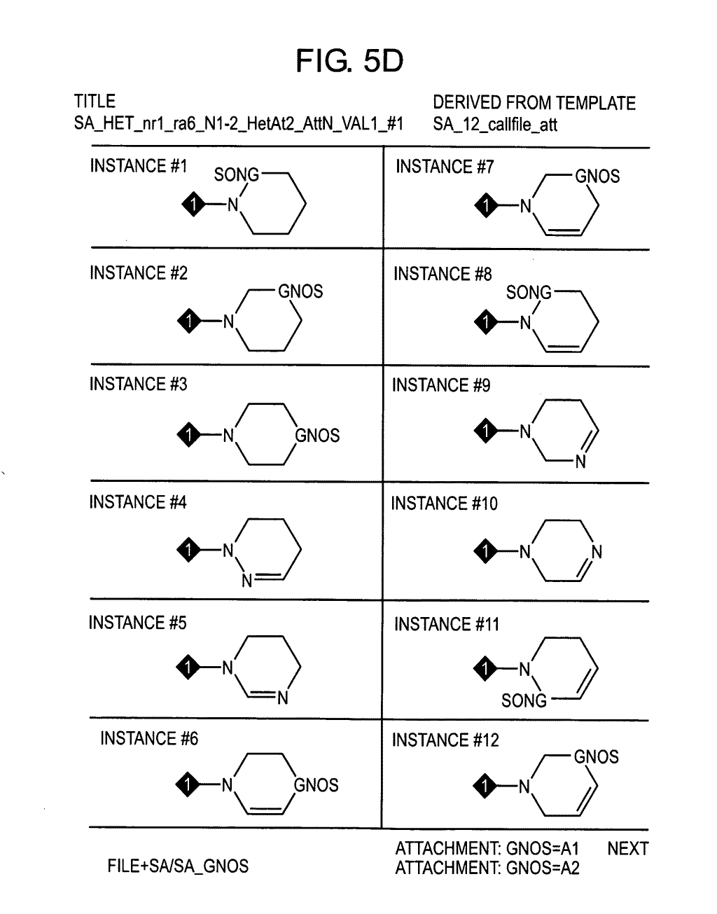

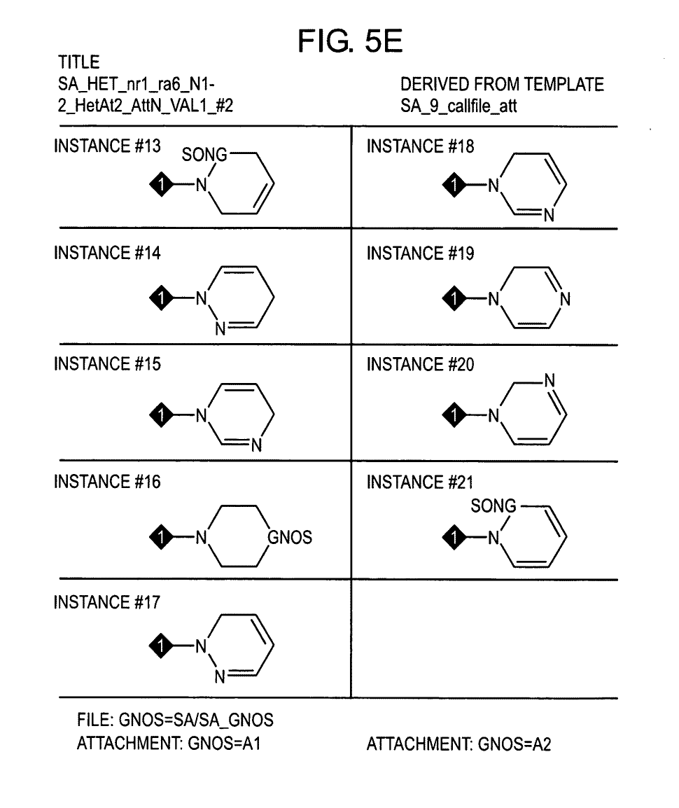

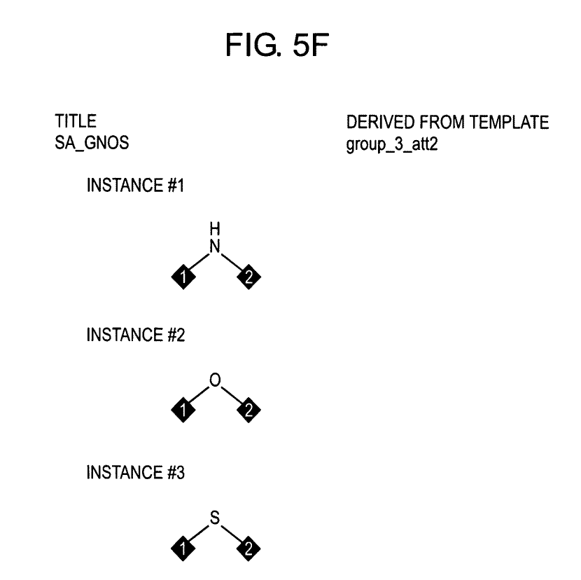

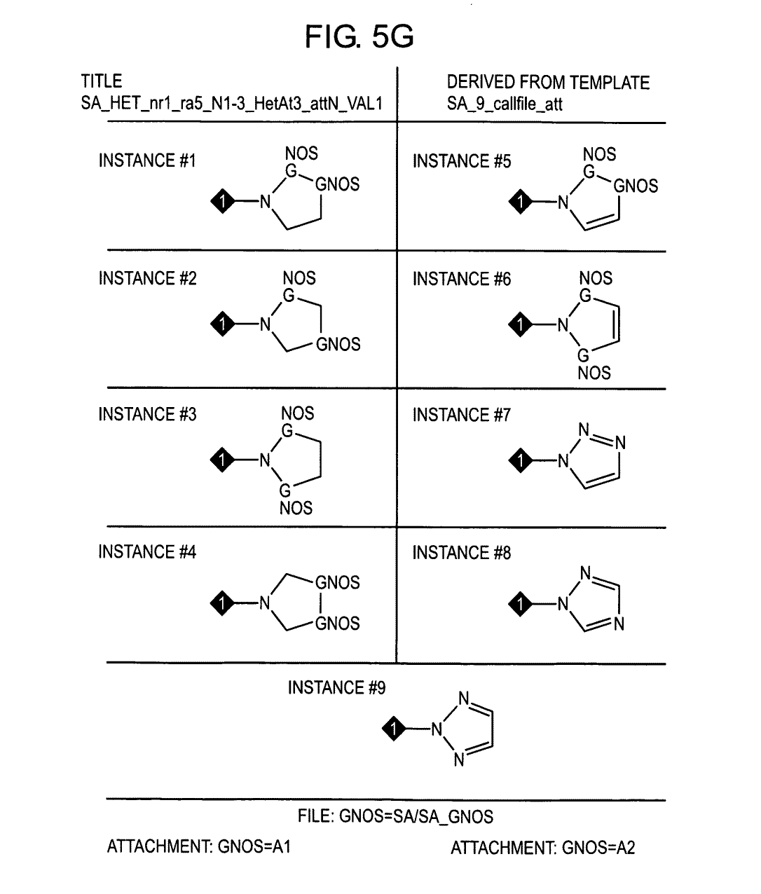

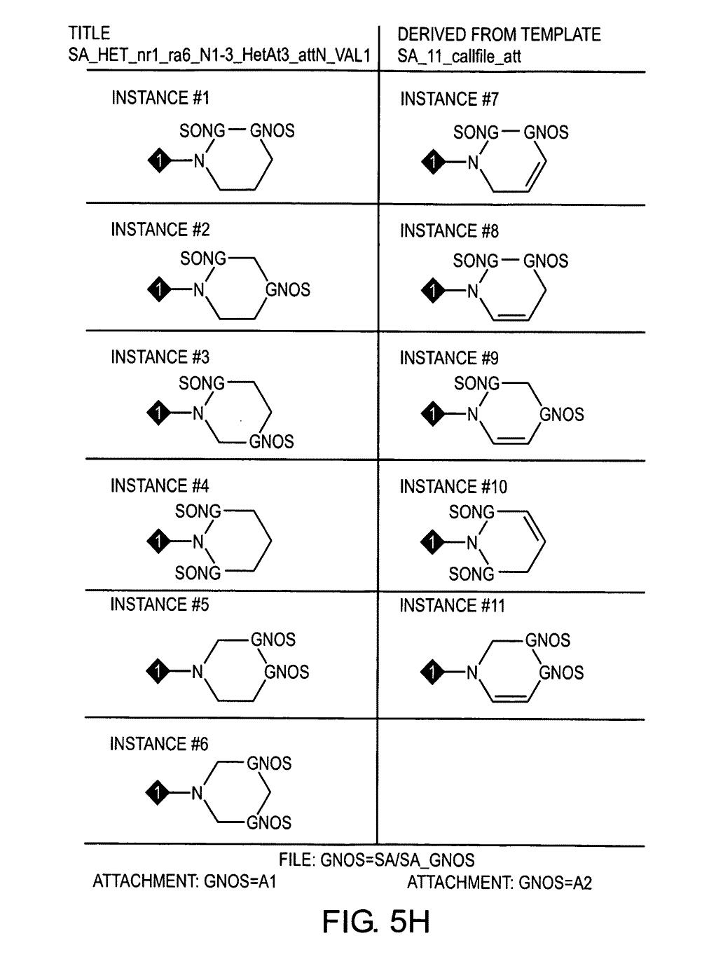

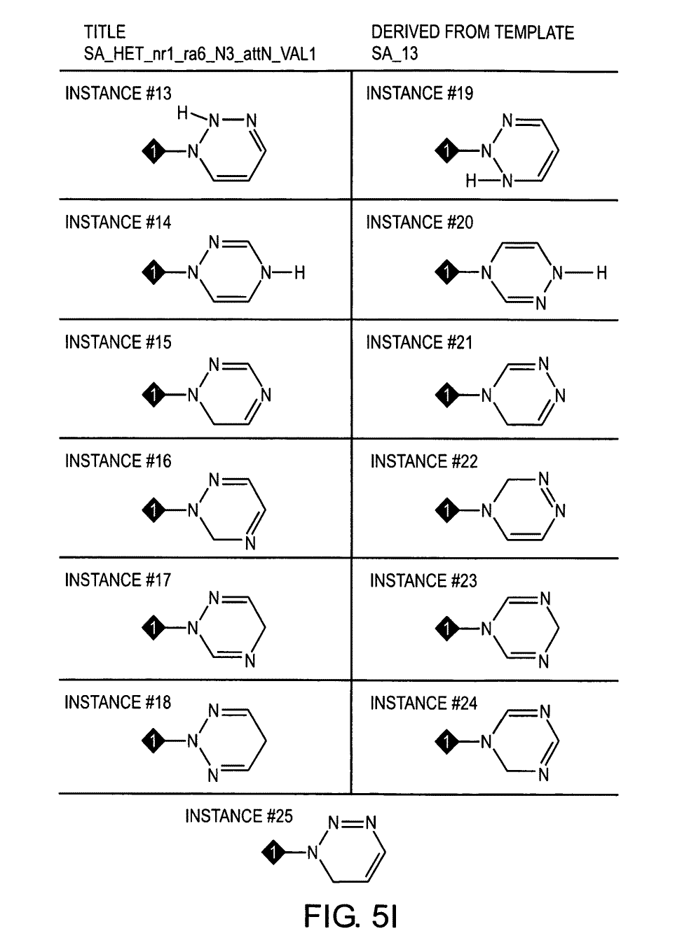

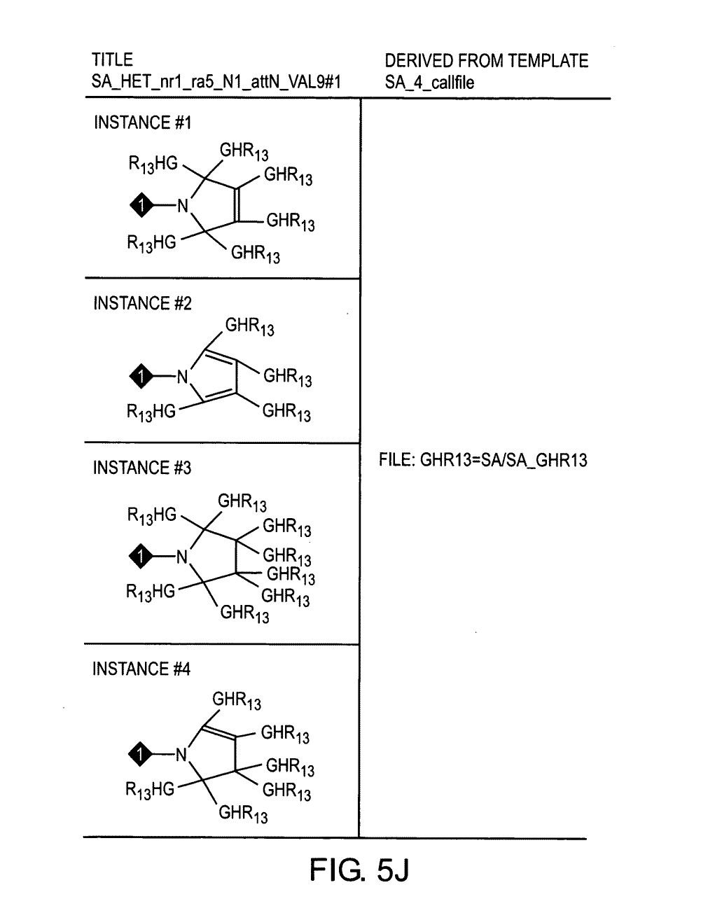

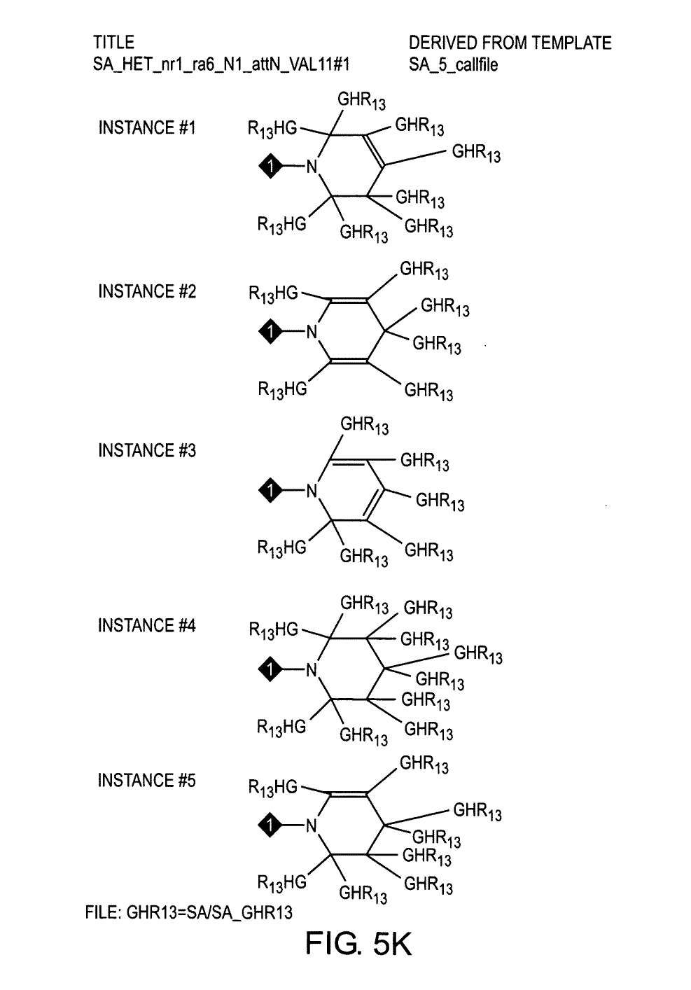

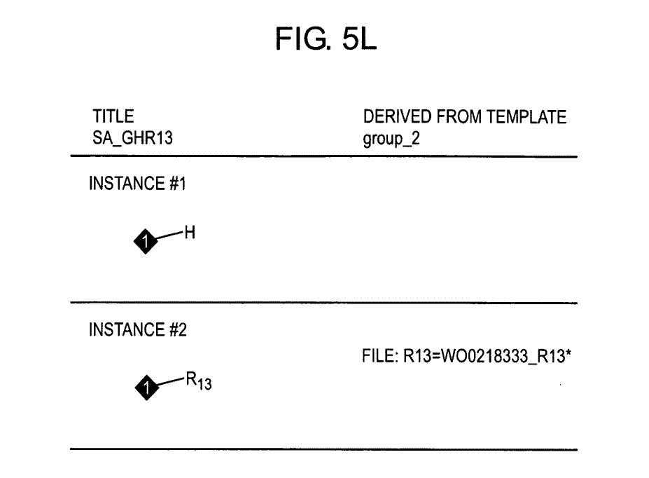

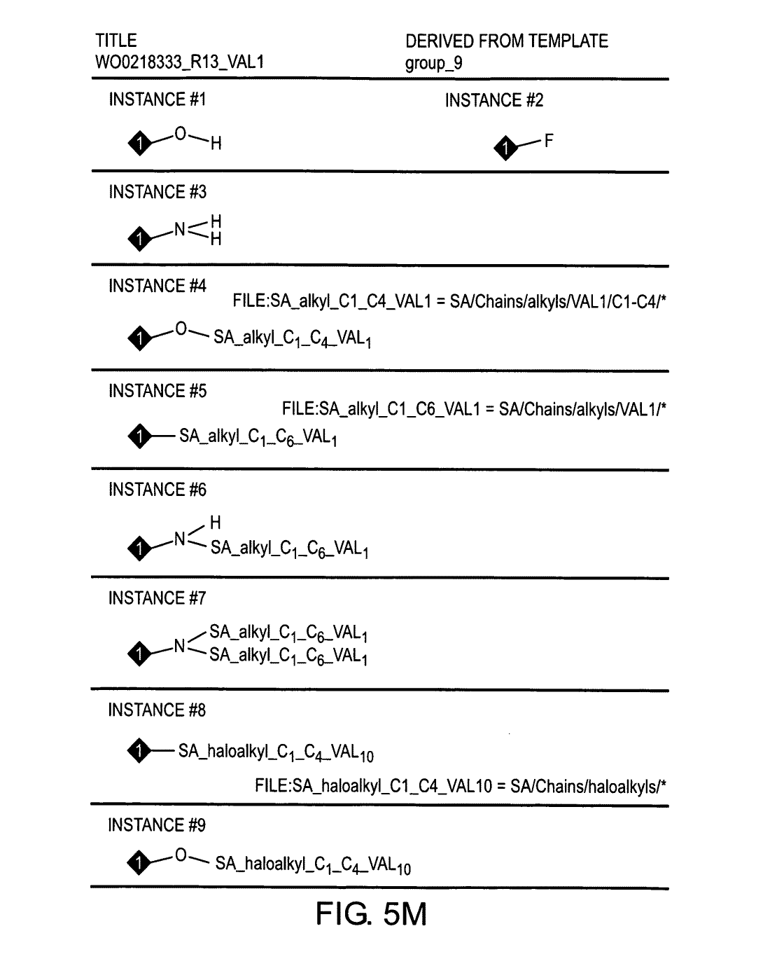

An example shown in FIGS. 5a-5m illustrates a section of a superatom library that enables the enumeration of generic chemical structure representation defining substituent groupings such as, for example, heteroatom ring systems containing all possible combinations of a nitrogen atom with 2 substituents as might be defined in the claims of a patent. The examples shown in these figures identify structure fragments and attachment points (depicted as a diamond containing the number 1 or 2) for each structure fragment. These fragment libraries are sorted by the number of heteroatoms and start with structure fragments containing 1 heteroatom. The first set of examples in FIGS. 5a and 5b identifies structure fragments defining ring systems containing 1 nitrogen atom. This series of fragments can be used for enumerating general chemical structure descriptions defining heterocyclic substituent groupings with ring sizes of 4-6 atoms containing 1 nitrogen atom. Thus specific species defined by super atom library definitions in generic chemical structure representations can be created by using superatom library fragments such as, for example, the fragments shown in FIGS. 5a-5m, at specific attachment points of a genus in accordance with the description provided by general chemical structure representations. Thus, for example, if there are no additional ring substituents specified in a patent claim or in the descriptions of general chemical structure representations, then the bonding valence of the ring superatom examples shown in the illustrated example would be 1, and the topological neighborhood of this ring superatom corresponds to the nearest neighbor of the N atom in the patent claim.

For purpose of file size limitation only, the examples shown in FIGS. 5a-5m are limited to a superatom library that can be used for constructing ring systems containing 4 to 6 ring atoms. This limitation should not be construed to limit the scope of this superatom library in any way, and in this case the description of the superatom library takes on the form of an independent Markush structure. For example, if general chemical structure descriptions require restriction of the enumeration to ring systems containing 1 to 3 hetero atoms selected from the group N, O or S, the superatom library system can create fragment libraries of representative examples from 5 to 6 atoms. A further aspect of this invention is that the content of the superatom library can be modified. For example, consideration of the chemical instability of ring systems containing more then two heteroatoms and less than four atoms can be used, if desired, to limit the scope of a default superatom library selected for conducting rapid comparative enumerations to superatom libraries containing fragments with ring sizes of less than 4 atoms, unless the end user requests addition of these superatom library definitions to the default library. Yet another aspect of the invention illustrated in the figures is the organization of superatom fragment databases according to specific parameters defining the structure of fragment libraries and its correspondence with terminology used in the MMS database, enabling rapid automated identification of correspondence between superatom definitions used by generic chemical structure descriptions and the MMS database, and allowing management of structure fragment databases and avoidance of redundancy. Yet a third aspect of the invention is the creation of database templates for easing the entry of new structures and for identifying structural relationships between templates.

Referring to FIGS. 5c-5e, the next set of examples illustrate the display with 2 heteroatoms including the mandatory nitrogen. An internal group is used for allowing the heteroatom option between N, 0 and S. The reference to the file representing this group and to the attachment of this group within the graph are then included. The reference to the attachment is visible only when activated by the user.

The first example of FIG. 5c is displayed for 5 atoms in the ring.

The second example of FIGS. 5d and 5e is displayed for 6 atoms. Finally, a graph of the internal generic group, GNOS, is displayed in FIG. 5f.

The last set of examples, starting with FIG. 5g, is with 3 heteroatoms in the ring, including the possibility that these 3 heteroatoms are nitrogen. The case of 6 atoms and 3 nitrogen will constitute a homogeneous graph since, from the biochemical point of view, this last family is important and corresponds to pyrimidyl. The corresponding structures are contained in the graph of FIG. 5i.

In another part of the patent claims, similar heterorings may be defined, but they are able to carry a given number of optional substituents defined in the patent, in this case as R13. Then, the resulting graphs will not be the same as those of the previous figures, but similar with the presence of this optional substituent. The examples of FIGS. 5j and 5k show this case only for rings with 1 nitrogen and are similar to the first graphs of FIGS. 5a and 5b. The optional substituent is represented by a new generic group called GHR13. This group contains another son group called R13 and defined in this case by the patent.

Thus, there are possible gateways between the superatoms database and the patent database. The name GHR13 has been built dynamically in a way to maintain the superatoms database completely independent from the patent database. It will be noticed that the G13 graph contains references to alkyl and haloalkyls substructures, which are represented by other superatoms belonging to the chains segment of the superatoms database.

A fourth aspect of the invention is the creation of Superatom libraries containing, for example, collections of structure fragments describing building blocks occurring, for example, in natural and unnatural amino acids or derivatives thereof, collections of structure fragments describing building blocks of Protein sequences, collections of structure fragments describing building blocks for DNA sequences and derivatives thereof, collections of structure fragments describing building blocks for RNA sequences and collections of structure fragments describing building blocks for carbohydrates or derivatives thereof enabling the combination of pertinent structure fragments or building blocks for creating specific protein, DNA, RNA or carbohydrate sequences if pertinent Markush structure descriptions so require.

All publications and patent applications cited in this specification are herein incorporated by reference as if each individual publication or patent application were specifically and individually indicated to be incorporated by reference. While the invention has been described in terms of various preferred embodiments, the skilled artisan will appreciate that various modifications, substitutions, omissions, and changes may be made without departing from the spirit thereof. Accordingly, it is intended that the scope of the present invention be limited solely by the scope of the following claims, including equivalents thereof.

### COMPUTER PROGRAM LISTING APPENDIX

### Files Contained on Accompanying Compact Disk

| Name | Creation Date | Size |
|---|---|---|
| .classpath | 7/15/2008 4:37 PM | 4,262 |
| .project | 5/14/2008 4:52 PM | 516 |
| org.eclipse.jdt.core.prefs | 5/14/2008 4:52 PM | 209 |
| core-assembly.xml | 6/14/2007 10:07 PM | 573 |
| pom.xml | 9/19/2008 2:55 PM | 9,762 |
| log4j.xml | 6/4/2008 12:11 PM | 3,256 |
| EnumerationBatch.java | 9/23/2008 1:25 PM | 8,114 |
| CN.java | 8/28/2008 3:48 PM | 1,403 |
| MMSPatentRequestHandler.java | 9/23/2008 1:25 PM | 24,402 |
| PatentRequestHandler.java | 9/23/2008 1:25 PM | 1,458 |
| PatentService.java | 9/9/2008 5:08 PM | 1,537 |
| PatentServiceImpl.java | 8/28/2008 3:48 PM | 2,384 |
| MmsBatch.java | 9/23/2008 1:25 PM | 6,797 |
| UpdateNbInstanceStructure.java | 9/23/2008 1:25 PM | 568 |
| DBManager.java | 9/23/2008 1:25 PM | 51,595 |
| DBManagerImpl.java | 9/23/2008 1:25 PM | 68,164 |
| Binary2MoleculeMapperImpl.java | 9/9/2008 5:08 PM | 4,730 |
| MoleculeDBMapper.java | 8/28/2008 3:48 PM | 1,461 |
| MoleculeEnumerationExporter.java | 8/28/2008 3:48 PM | 3,028 |
| MoleculeEnumerationListener.java | 8/28/2008 3:48 PM | 3,475 |
| MoleculeMapper.java | 8/28/2008 3:48 PM | 2,808 |
| MoleculeMapperException.java | 8/28/2008 3:48 PM | 2,000 |
| CDXML2SDFTranscoder.java | 8/28/2008 3:48 PM | 697 |
| SDF2MoleculeMapperImpl.java | 9/9/2008 5:08 PM | 21,896 |
| XML2MoleculeMapperImpl.java | 9/9/2008 5:08 PM | 16,326 |
| Binary2MarkushMapperImpl.java | 8/28/2008 3:48 PM | 3,064 |
| BondFromBTypeFactory.java | 8/28/2008 3:48 PM | 3,766 |
| CDXML2MarkushMapperImpl.java | 9/9/2008 5:08 PM | 22,471 |
| ChemicalProperty.java | 9/6/2008 9:20 AM | 15,091 |
| ChemicalPropertyHandler.java | 8/28/2008 3:48 PM | 7,679 |
| GroupStructureFromFragmentTypeFacto... | 9/9/2008 5:08 PM | 4,343 |
| NodeFromNTypeFactory.java | 9/9/2008 5:08 PM | 6,937 |
| RuleFromCDXMLFactory.java | 8/28/2008 3:48 PM | 450 |
| StructureFiles.java | 9/9/2008 5:08 PM | 17,592 |
| StructureFilesProperty.java | 9/9/2008 5:08 PM | 3,641 |
| MarkushMapper.java | 8/28/2008 3:48 PM | 2,478 |
| MarkushMapperException.java | 8/28/2008 3:48 PM | 4,538 |
| StoreMMSStructureXML.java | 9/23/2008 1:25 PM | 809 |
| MMS2MarkushMapperImpl.java | 8/28/2008 3:48 PM | 10,461 |
| MMSException.java | 8/28/2008 3:48 PM | 4,413 |
| CachePatentRequestHandler.java | 9/23/2008 1:25 PM | 6,429 |
| CN.java | 9/9/2008 5:08 PM | 1,090 |
| MMSPatentRequestHandler.java | 9/23/2008 6:49 PM | 21,891 |
| PatentRequestHandler.java | 8/28/2008 3:48 PM | 2,036 |
| PatentService.java | 9/9/2008 5:08 PM | 1,521 |
| PatentServiceImpl.java | 8/28/2008 3:48 PM | 4,468 |
| ResultMMS.java | 8/28/2008 3:48 PM | 3,071 |
| Questel2MarkushMapperImpl.java | 8/28/2008 3:48 PM | 132,943 |
| RegexRulFileFinder.java | 9/9/2008 5:08 PM | 1,468 |
| RUL2RulesMapperImpl.java | 9/9/2008 5:08 PM | 6,219 |
| RulesMapper.java | 8/28/2008 3:48 PM | 915 |
| RulesMapperException.java | 8/28/2008 3:48 PM | 1,844 |
| ImportToolsException.java | 8/28/2008 3:48 PM | 1,621 |
| ImportToolsManager.java | 9/9/2008 5:08 PM | 701 |
| ImportToolsManagerImpl.java | 9/23/2008 1:25 PM | 23,190 |
| SAKeywordInfo.java | 9/23/2008 1:25 PM | 1,153 |
| CoreOptions.java | 8/28/2008 3:48 PM | 4,223 |
| Element.java | 8/28/2008 3:48 PM | 4,328 |
| Group.java | 8/28/2008 3:48 PM | 941 |
| periodictable.csv | 4/10/2007 6:33 PM | 6,328 |
| PeriodicTable.java | 9/9/2008 5:08 PM | 3,724 |
| PeriodicTableException.java | 8/28/2008 3:48 PM | 1,563 |
| PeriodicTableImpl.java | 9/9/2008 5:08 PM | 8,465 |
| Attachment.java | 9/9/2008 5:08 PM | 7,422 |
| Group.java | 9/9/2008 5:08 PM | 27,742 |
| GroupStructure.java | 9/9/2008 5:08 PM | 14,108 |
| Instance.java | 9/9/2008 5:08 PM | 6,967 |
| MarkushException.java | 8/28/2008 3:48 PM | 4,095 |
| RootStructure.java | 8/28/2008 3:48 PM | 7,059 |
| Structure.java | 9/9/2008 5:08 PM | 8,695 |
| SuperAtom.java | 9/9/2008 5:08 PM | 872 |
| Metadata.java | 9/9/2008 5:08 PM | 128 |
| Atom.java | 8/28/2008 3:48 PM | 3,857 |
| Bond.java | 9/9/2008 5:08 PM | 7,062 |
| Molecule.java | 9/9/2008 5:08 PM | 4,544 |
| MoleculeException.java | 8/28/2008 3:48 PM | 1,000 |
| Node.java | 9/9/2008 5:08 PM | 1,192 |
| Patent.java | 8/28/2008 3:48 PM | 968 |
| VersionCore.java | 9/23/2008 1:25 PM | 490 |
| EnumerationEvent.java | 8/28/2008 3:48 PM | 1,958 |
| EnumerationListener.java | 8/28/2008 3:48 PM | 1,058 |
| Enumerator.java | 9/9/2008 5:08 PM | 22,456 |
| InMemoryEnumerationAppender.java | 8/28/2008 3:48 PM | 2,280 |
| Expression.java | 8/28/2008 3:48 PM | 4,416 |
| ExpressionAnd.java | 8/28/2008 3:48 PM | 1,187 |
| ExpressionComp.java | 8/28/2008 3:48 PM | 1,166 |
| ExpressionIn.java | 8/28/2008 3:48 PM | 1,614 |
| ExpressionOr.java | 8/28/2008 3:48 PM | 1,183 |
| Fact.java | 8/28/2008 3:48 PM | 1,653 |
| RuleObject.java | 8/28/2008 3:48 PM | 2,126 |
| SingleTermExpression.java | 8/28/2008 3:48 PM | 933 |
| StringData.java | 8/28/2008 3:48 PM | 705 |
| TermExpression.java | 8/28/2008 3:48 PM | 298 |
| Variable.java | 8/28/2008 3:48 PM | 904 |
| ParseException.java | 8/28/2008 3:48 PM | 4,642 |
| rule.jj | 9/13/2007 11:00 ... | 14,121 |
| RulesParser.java | 8/28/2008 3:48 PM | 52,167 |
| RulesParserConstants.java | 8/28/2008 3:48 PM | 4,251 |
| RulesParserTokenManager.java | 8/28/2008 3:48 PM | 50,189 |
| SimpleCharStream.java | 8/28/2008 3:48 PM | 19,149 |
| Token.java | 8/28/2008 3:48 PM | 915 |
| TokenMgrError.java | 8/28/2008 3:48 PM | 4,434 |
| MoleculeEnumerationApplyRule.java | 8/28/2008 3:48 PM | 3,008 |
| RulesEngine.java | 8/28/2008 3:48 PM | 13,681 |
| RulesEngineException.java | 8/28/2008 3:48 PM | 1,827 |
| Rule.java | 9/9/2008 5:08 PM | 783 |
| rulesparser.jar | 6/15/2007 2:03 PM | 44,580 |
| DrawService.java | 9/18/2008 11:08 ... | 957 |
| DrawServiceImpl.java | 9/23/2008 1:25 PM | 1,817 |
| EnumerationService.java | 9/23/2008 1:25 PM | 10,809 |
| EnumerationServiceImpl.java | 9/23/2008 1:25 PM | 22,431 |
| PayService.java | 9/18/2008 11:08 ... | 1,743 |
| PayServiceImpl.java | 9/18/2008 11:08 ... | 2,513 |
| RegisterBatch.java | 9/23/2008 1:25 PM | 4,439 |
| SearchService.java | 9/23/2008 1:25 PM | 4,930 |
| SearchServiceImpl.java | 9/23/2008 1:25 PM | 9,218 |
| SecurityService.java | 9/23/2008 1:25 PM | 3,838 |
| SecurityServiceImpl.java | 9/23/2008 1:25 PM | 8,328 |
| SessionService.java | 9/23/2008 1:25 PM | 8,946 |
| SessionServiceImpl.java | 9/23/2008 1:25 PM | 12,372 |
| TransService.java | 9/23/2008 1:25 PM | 2,110 |
| TransServiceImpl.java | 9/23/2008 1:25 PM | 5,340 |
| Core.java | 9/9/2008 5:08 PM | 22,530 |
| EnumeratorGUIException.java | 9/23/2008 1:25 PM | 4,649 |
| EnumeratorInterfaceController.java | 9/23/2008 1:25 PM | 1,209 |
| EnumeratorInterfaceLogView.java | 9/23/2008 1:25 PM | 8,542 |
| EnumeratorInterfaceModel.java | 9/23/2008 1:25 PM | 6,031 |
| EnumeratorInterfaceView.java | 9/23/2008 1:25 PM | 37,582 |
| FiltreExtensible.java | 9/23/2008 1:25 PM | 2,319 |
| JTextAreaAppender.java | 9/23/2008 1:25 PM | 1,712 |
| ImagesCacheManager.java | 9/23/2008 1:25 PM | 823 |
| ImagesCacheManagerImpl.java | 9/23/2008 1:25 PM | 6,564 |
| MailGenerator.java | 8/28/2008 3:48 PM | 616 |
| MailGeneratorImpl.java | 8/28/2008 3:48 PM | 2,893 |
| ZipUnzipFile.java | 9/23/2008 1:25 PM | 8,972 |
| DrawGenerator.java | 9/9/2008 5:08 PM | 943 |
| DrawGeneratorImpl.java | 9/23/2008 1:25 PM | 3,722 |
| CSVReader.java | 9/9/2008 5:08 PM | 5,496 |
| DomainObject.java | 8/28/2008 3:48 PM | 3,346 |
| BaseException.java | 8/28/2008 3:48 PM | 5,002 |
| Case.java | 8/28/2008 3:48 PM | 2,208 |
| CaseLevel.java | 8/28/2008 3:48 PM | 1,901 |
| TechnicalException.java | 8/28/2008 3:48 PM | 881 |
| Immutable.java | 9/9/2008 5:08 PM | 126 |
| Mutable.java | 9/9/2008 5:08 PM | 122 |
| InchiBatch.java | 9/23/2008 1:25 PM | 4,987 |
| InchiBatchDB.java | 9/23/2008 1:25 PM | 6,036 |
| InchiException.java | 8/28/2008 3:48 PM | 2,870 |
| JobAnalyzer.java | 9/23/2008 1:25 PM | 428 |
| JobAnalyzerFileImpl.java | 9/23/2008 1:25 PM | 1,746 |
| JobManager.java | 9/23/2008 1:25 PM | 1,265 |
| JobManagerFileImpl.java | 9/23/2008 1:25 PM | 6,436 |
| JobThread.java | 9/23/2008 1:25 PM | 1,047 |
| InchiInfo.java | 9/23/2008 1:25 PM | 2,301 |
| JobElement.java | 8/28/2008 3:48 PM | 1,572 |
| JobTask.java | 8/28/2008 3:48 PM | 1,533 |
| DuplicateManager.java | 9/9/2008 5:08 PM | 1,286 |
| File2DuplicateManagerImpl.java | 8/28/2008 3:48 PM | 5,412 |
| File2InchiGeneratorImpl.java | 9/9/2008 5:08 PM | 8,970 |
| InchiGenerator.java | 9/9/2008 5:08 PM | 1,050 |
| ReportError.java | 9/23/2008 1:25 PM | 2,106 |
| ReportGenerator.java | 9/9/2008 5:08 PM | 579 |
| ReportGeneratorImpl.java | 9/23/2008 1:25 PM | 732 |
| ReportGeneratorListener.java | 9/23/2008 1:25 PM | 19,342 |
| importCdxml.bat | 6/4/2008 8:22 PM | 817 |
| importCdxml.sh | 8/6/2008 12:14 PM | 550 |
| importMMS.bat | 6/4/2008 8:22 PM | 833 |
| importMMs.sh | 8/6/2008 12:14 PM | 548 |
| importSuperAtom.bat | 6/3/2008 5:03 PM | 863 |
| importSuperAtom.sh | 8/6/2008 12:14 PM | 532 |
| jdbc.properties | 7/21/2008 1:51 PM | 154 |
| libstdc++.so.5.0.3 | 7/21/2008 1:51 PM | 709,488 |
| runEnumBatch.bat | 6/18/2008 7:17 PM | 715 |
| runEnumBatch.sh | 8/6/2008 12:14 PM | 479 |
| runInchiBatch.bat | 6/18/2008 7:17 PM | 692 |
| runInchiBatch.sh | 7/23/2008 6:19 PM | 531 |
| runMMsBatch.bat | 6/18/2008 7:17 PM | 708 |
| runMMsBatch.sh | 8/6/2008 12:14 PM | 472 |
| runRegister.bat | 6/4/2008 4:14 PM | 824 |
| runRegister.sh | 6/4/2008 8:14 PM | 573 |
| beans.xml | 9/23/2008 1:26 PM | 4,319 |
| activation.jar | 8/8/2008 5:18 PM | 56,290 |
| dsn.jar | 8/8/2008 5:18 PM | 10,511 |
| imap.jar | 8/8/2008 5:18 PM | 142,714 |
| mailapi.jar | 8/8/2008 5:18 PM | 193,741 |
| pop3.jar | 8/8/2008 5:18 PM | 21,049 |
| smtp.jar | 8/8/2008 5:18 PM | 24,537 |
| Manifest.mf | 6/14/2007 11:03 PM | 118 |
| buildandclean.bat | 9/30/2008 11:01 ... | 2,923 |
| buildandclean.sh | 9/30/2008 11:01 ... | 1,811 |
| versionCore.properties | 9/18/2008 11:10 ... | 13 |
| cdxml.jar | 8/13/2007 10:55 PM | 90,185 |
| cdxml.xsd | 8/8/2007 11:23 PM | 8,498 |
| cdxml.xsdconfig | 4/10/2007 6:33 PM | 591 |
| genxmlbeans.sh | 8/8/2007 11:23 PM | 1,312 |
| questel.jar | 8/13/2007 10:55 PM | 61,824 |
| questel.xsd | 4/17/2008 3:10 PM | 3,241 |
| questel.xsdconfig | 8/8/2007 11:23 PM | 593 |
| TestDrawService.java | 8/4/2008 6:10 PM | 1,341 |
| SDF2MoleculeMapperImplTest.java | 5/22/2008 3:50 PM | 9,126 |
| CDXML2MarkushMapperTest.java | 3/26/2008 4:47 PM | 3,794 |
| mol2.jpg | 5/29/2007 6:45 PM | 33,352 |
| mol2.sdf | 5/29/2007 6:45 PM | 3,585 |
| WO666666_R0_#0_#0.xml | 5/29/2007 11:16 ... | 6,123 |
| ImportTools.java | 4/16/2008 4:38 PM | 5,429 |
| MMS2MarkushMapperImplTest.java | 8/9/2007 9:59 AM | 728 |
| MMSPatentRequestTest.java | 5/16/2008 4:19 PM | 1,515 |
| WC000101.f1q | 6/1/2007 12:59 AM | 29,951 |
| questel.xml | 8/13/2007 10:54 ... | 59,447 |
| QuestelMarkushMapperImplTest.java | 5/22/2008 3:50 PM | 3,262 |
| CdkInchiTest.java | 3/26/2008 4:47 PM | 2,622 |
| InchiTest.sdf | 2/29/2008 1:16 PM | 3,823 |
| Sdf2Molecul.java | 2/21/2008 7:37 PM | 2,925 |
| TestInchiWrapper.java | 2/21/2008 7:39 PM | 3,323 |
| MmsPatentRequest.java | 5/27/2008 11:31 ... | 808 |
| PeriodicTableTest.java | 4/10/2007 6:33 PM | 2,101 |
| EnumeratorTest.java | 5/22/2008 3:50 PM | 7,059 |
| RulesEngineTest.java | 5/22/2008 3:50 PM | 7,327 |
| TestReport.java | 9/18/2008 11:14 ... | 5,273 |
| Enumeration.java | 7/15/2008 4:27 PM | 8,348 |
| Register.java | 9/18/2008 11:13 ... | 980 |
| Search.java | 9/18/2008 11:13 ... | 3,500 |
| Session.java | 9/18/2008 11:13 ... | 3,068 |
| Users.java | 8/4/2008 6:10 PM | 2,647 |
| .classpath | 5/7/2008 12:45 PM | 2,305 |
| .project | 3/24/2008 2:04 PM | 358 |
| db-assembly.xml | 3/23/2008 1:00 AM | 550 |
| pom.xml | 9/18/2008 11:27 ... | 3,883 |
| log4j.xml | 6/12/2008 7:53 PM | 3,095 |
| beanCore.xml | 9/24/2008 4:24 PM | 8,369 |
| beans.xml | 9/9/2008 2:38 PM | 8,367 |
| beanWeb.xml | 9/24/2008 4:24 PM | 8,367 |
| BatchDAO.java | 9/23/2008 1:27 PM | 8,607 |
| BatchDAOImpl.java | 9/23/2008 1:27 PM | 14,287 |
| CdxmlDAO.java | 9/9/2008 2:36 PM | 3,465 |
| CdxmlDAOImpl.java | 8/28/2008 3:39 PM | 5,845 |
| CnDAO.java | 9/23/2008 1:27 PM | 5,199 |
| CnDAOImpl.java | 9/23/2008 1:27 PM | 8,742 |
| CompanyDAO.java | 9/9/2008 2:36 PM | 3,452 |
| CompanyDAOImpl.java | 9/9/2008 2:36 PM | 9,698 |
| EnumerationDAO.java | 9/23/2008 1:27 PM | 9,131 |
| EnumerationDAOImpl.java | 9/23/2008 1:27 PM | 16,563 |
| InvoiceDAO.java | 9/23/2008 1:27 PM | 2,068 |
| InvoiceDAOImpl.java | 9/23/2008 1:27 PM | 4,508 |
| KeywordDAO.java | 9/9/2008 2:36 PM | 3,023 |
| KeywordDAOImpl.java | 9/9/2008 2:36 PM | 4,362 |
| MetadataDAO.java | 9/23/2008 1:27 PM | 1,688 |
| MetadataDAOImpl.java | 9/23/2008 1:27 PM | 4,190 |
| MoleculeDAO.java | 9/23/2008 1:27 PM | 2,671 |
| MoleculeDAOImpl.java | 9/23/2008 1:27 PM | 6,410 |
| PatentDAO.java | 9/9/2008 2:36 PM | 5,818 |
| PatentDAOImpl.java | 9/9/2008 2:36 PM | 9,909 |
| RuleDAO.java | 9/23/2008 1:27 PM | 1,312 |
| RuleDAOImpl.java | 9/23/2008 1:27 PM | 3,168 |
| SecurityDAO.java | 9/23/2008 1:27 PM | 3,838 |
| SecurityDAOImpl.java | 9/23/2008 1:27 PM | 5,930 |
| StructureDAO.java | 9/23/2008 1:27 PM | 7,912 |
| StructureDAOImpl.java | 10/3/2008 12:04 PM | 16,524 |
| SupportRequestDAO.java | 9/9/2008 2:36 PM | 4,276 |
| SupportRequestDAOImpl.java | 9/9/2008 2:36 PM | 11,199 |
| UserDAO.java | 9/9/2008 2:36 PM | 4,365 |
| UserDAOImpl.java | 9/9/2008 2:36 PM | 10,455 |
| DBException.java | 9/18/2008 11:15 ... | 25,077 |
| DBversion.java | 9/18/2008 11:42 ... | 777 |
| BatchStatus.java | 8/28/2008 3:39 PM | 218 |
| BatchType.java | 8/28/2008 3:39 PM | 178 |
| CnType.java | 8/28/2008 3:39 PM | 180 |
| EnumerationStatus.java | 8/28/2008 3:39 PM | 440 |
| EnumerationType.java | 8/28/2008 3:39 PM | 214 |
| Extension.java | 8/28/2008 3:39 PM | 121 |
| GlobalSdfType.java | 8/28/2008 3:39 PM | 218 |
| MetadataType.java | 8/28/2008 3:39 PM | 438 |
| PatentStatus.java | 8/28/2008 3:39 PM | 306 |
| SdfType.java | 8/28/2008 3:39 PM | 174 |
| StructureStatus.java | 8/28/2008 3:39 PM | 242 |
| StructureType.java | 8/28/2008 3:39 PM | 230 |
| SupportRequestStatus.java | 8/28/2008 3:39 PM | 206 |
| SupportRequestType.java | 8/28/2008 3:39 PM | 204 |
| SupportStatus.java | 8/28/2008 3:39 PM | 304 |
| SupportType.java | 8/28/2008 3:39 PM | 182 |
| BaseException.java | 8/28/2008 3:39 PM | 5,107 |
| Case.java | 8/28/2008 3:39 PM | 2,442 |
| CaseLevel.java | 8/28/2008 3:39 PM | 1,964 |
| GetBeanContext.java | 8/28/2008 3:39 PM | 2,935 |
| InitDataSource.java | 9/23/2008 1:27 PM | 2,283 |
| Batch.java | 9/4/2008 6:31 PM | 4,876 |
| Cdxml.java | 8/28/2008 3:39 PM | 1,434 |
| Cn.java | 8/28/2008 3:39 PM | 3,589 |
| Company.java | 8/28/2008 3:39 PM | 3,745 |
| Enumeration.java | 8/28/2008 3:39 PM | 9,379 |
| EnumerationResponse.java | 8/28/2008 3:39 PM | 1,092 |
| InchiProcessInfo.java | 8/28/2008 3:39 PM | 2,201 |
| Invoices.java | 8/28/2008 3:39 PM | 1,345 |
| Keyword.java | 8/28/2008 3:39 PM | 2,902 |
| Metadata.java | 8/28/2008 3:39 PM | 3,383 |
| Molecule.java | 8/28/2008 3:39 PM | 3,521 |
| Patent.java | 8/28/2008 3:39 PM | 4,165 |
| Rule.java | 8/28/2008 3:39 PM | 2,916 |
| Structure.java | 8/28/2008 3:39 PM | 5,670 |
| SupportRequest.java | 8/28/2008 3:39 PM | 3,940 |
| User.java | 8/28/2008 3:39 PM | 5,846 |
| BatchLn.java | 9/4/2008 6:31 PM | 4,822 |
| BatchLnStructure.java | 8/28/2008 3:39 PM | 3,593 |
| ChildCdxml.java | 8/28/2008 3:39 PM | 1,111 |
| ChildStructureBatch.java | 8/28/2008 3:39 PM | 1,081 |
| CnInfo.java | 8/28/2008 3:39 PM | 1,658 |
| CnSearch.java | 8/28/2008 3:39 PM | 3,349 |
| DetailCDXML.java | 8/28/2008 3:39 PM | 1,515 |
| DetailPatent.java | 8/28/2008 3:39 PM | 1,065 |
| EnumInfo.java | 8/28/2008 3:39 PM | 8,021 |
| FileInfo.java | 8/28/2008 3:39 PM | 899 |
| InvoiceLine.java | 8/28/2008 3:39 PM | 3,176 |
| Keyword.java | 8/28/2008 3:39 PM | 1,095 |
| Manage.java | 8/28/2008 3:39 PM | 1,099 |
| PatentInfo.java | 8/28/2008 3:39 PM | 2,413 |
| PatentSearch.java | 8/28/2008 3:39 PM | 3,115 |
| PreviousBatch.java | 9/4/2008 6:32 PM | 722 |
| Report.java | 8/28/2008 3:39 PM | 12,612 |
| ReportPatent.java | 8/28/2008 3:39 PM | 1,142 |
| ReportStructure.java | 8/28/2008 3:39 PM | 1,142 |
| Shortcut.java | 8/28/2008 3:39 PM | 871 |
| StructureCdxml.java | 8/28/2006 3:39 PM | 2,301 |
| StructureInfo.java | 8/28/2008 3:39 PM | 1,454 |
| SuperAtom.java | 8/28/2008 3:39 PM | 4,635 |
| SupportRequest.java | 8/28/2008 3:39 PM | 5,409 |
| UserIdent.java | 8/28/2008 3:39 PM | 1,411 |
| UserProfile.java | 8/28/2008 3:39 PM | 4,932 |
| VersionDB.java | 9/18/2008 11:20 ... | 283 |
| EnumerationManager.java | 9/23/2008 1:27 PM | 25,968 |
| EnumerationManager.Impl.java | 9/23/2008 1:27 PM | 64,962 |
| KeywordManager.java | 9/23/2008 1:27 PM | 3,826 |
| KeywordManagerImpl.java | 9/23/2008 1:27 PM | 5,599 |
| SecurityManager.java | 9/23/2008 1:27 PM | 3,531 |
| SecurityManagerImpl.java | 9/23/2008 1:27 PM | 5,277 |
| StructureManager.java | 9/23/2008 1:27 PM | 18,036 |
| StructureManager.Impl.java | 9/23/2008 1:27 PM | 36,602 |
| UserManager.java | 9/9/2008 2:36 PM | 11,942 |
| UserManager.Impl.java | 9/23/2008 1:27 PM | 21,267 |
| versionDB.properties | 9/18/2008 11:16 ... | 13 |
| 0.script_init_schema.sql | 8/29/2008 11:57 ... | 885 |
| 1.delete323.2.sql | 8/29/2008 11:57 ... | 974 |
| 2.create_dev.sql | 9/12/2008 11:45 ... | 17,914 |
| 2.create_integ.sql | 9/10/2008 10:30 ... | 17,324 |
| 2.create323.2.sql | 8/29/2008 11:57 ... | 9,558 |
| 3.script_init_table_Acegi_and_Tomcat.sql | 6/4/2008 8:19 PM | 1,177 |
| 4.script_init_data_Acegi and Tomcat.sql | 9/18/2008 5:43 PM | 22,003 |
| 5.script_init_data_company_and_user_... | 9/18/2008 5:43 PM | 2,303 |
| 6.script_init_data_menu.sql | 6/18/2008 11:14 ... | 1,085 |
| 7.script_init_data_menu_role.sql | 6/18/2008 3:05 PM | 2,155 |
| 8.script_init_data_invoices_invoice_line.sql | 6/30/2008 1:05 AM | 415 |
| 9.script_init_table_PDFTEXT.sql | 8/29/2008 11:56 ... | 6,742 |
| Global_Integration_Script.sql | 9/18/2008 12:24 PM | 56,632 |
| ConnexionTest.java | 4/23/2008 10:06 ... | 364 |
| TestEnum.java | 8/4/2008 6:12 PM | 403 |
| .classpath | 4/16/2008 6:58 PM | 9,109 |
| .project | 4/14/2008 8:24 PM | 508 |
| org.eclipse.jdt.core.prefs | 4/14/2008 8:24 PM | 209 |
| pom.xml | 4/16/2008 2:50 PM | 5,115 |
| log4j.xml | 4/16/2008 6:58 PM | 3,094 |
| bean.xml | 4/21/2008 2:54 PM | 4,649 |
| Consumer.java | 4/16/2008 6:58 PM | 3,887 |
| EnumConsumer.java | 4/16/2008 6:58 PM | 2,954 |
| EchoBean.java | 4/16/2008 6:58 PM | 1,276 |
| EnumerationConsumer.java | 4/21/2008 12:25 PM | 1,555 |
| EnumerationParams.java | 4/21/2008 12:25 PM | 1,703 |
| GetMqContext.java | 4/21/2008 3:27 PM | 1,021 |
| EnumerationProducer.java | 4/21/2008 12:25 PM | 1,513 |
| EnumProducer.java | 4/17/2008 6:09 PM | 2,106 |
| EnumerationMqService.java | 4/21/2008 3:29 PM | 127 |
| EnumerationMqService.Impl.java | 4/21/2008 3:29 PM | 1,561 |
| SpringTestSupport.java | 4/17/2008 6:09 PM | 2,678 |
| Test.java | 4/14/2008 8:24 PM | 4,129 |
| activemq.xml | 4/17/2008 6:08 PM | 7,573 |
| bean.xml | 4/17/2008 6:08 PM | 4,263 |
| .classpath | 7/15/2008 4:25 PM | 4,144 |
| .project | 4/22/2008 3:38 PM | 305 |
| pom.xml | 9/25/2008 11:45 ... | 5,982 |
| log4j.xml | 4/21/2008 6:58 PM | 1,471 |
| AuthorizationFilter.java | 9/23/2008 1:33 PM | 4,632 |
| AuthorizationManager.java | 9/11/2008 12:11 PM | 609 |
| AuthorizationManagerImpl.java | 9/11/2008 12:11 PM | 720 |
| CheckForWs.java | 9/23/2008 1:33 PM | 3,765 |
| MyAccountController.java | 9/23/2008 1:33 PM | 278 |
| EnumerationController.java | 9/23/2008 1:33 PM | 24,811 |
| SessionsAdminController.java | 9/23/2008 1:33 PM | 9,737 |
| ErrorController.java | 9/18/2008 11:39 ... | 1,480 |
| InvoiceController.java | 9/23/2008 1:33 PM | 3,520 |
| InvoicesAdminController.java | 9/23/2008 1:33 PM | 4,092 |
| KeywordController.java | 9/23/2008 1:33 PM | 3,778 |
| LoginController.java | 9/23/2008 1:33 PM | 10,628 |
| ManagerController.java | 9/23/2008 1:33 PM | 208 |
| PatentsController.java | 9/23/2008 1:33 PM | 6,261 |
| CompaniesAdminController.java | 9/23/2008 1:33 PM | 10,858 |
| SessionController.java | 9/23/2008 1:33 PM | 17,412 |
| SupportRequestsAdminController.java | 9/23/2008 1:33 PM | 5,283 |
| UsersAdminController.java | 9/23/2008 1:33 PM | 21,078 |
| StructureController.java | 9/23/2008 1:33 PM | 9,184 |
| SuperAtomsController.java | 9/23/2008 1:33 PM | 15,547 |
| ExportFileServlet.java | 9/26/2008 6:44 PM | 3,119 |
| ExportGlobalSDFFilesServlet.java | 9/26/2008 6:44 PM | 2,890 |
| ExportPdfReportServlet.java | 9/26/2008 2:42 PM | 2,982 |
| FileUploadController.java | 9/23/2008 1:33 PM | 7,806 |
| GetGeneratedImageServlet.java | 9/23/2008 1:33 PM | 2,117 |
| UserDao.java | 9/11/2008 12:11 PM | 4,496 |
| UserDaoImpl.java | 9/23/2008 1:33 PM | 6,978 |
| UserManager.java | 9/11/2008 12:11 PM | 3,365 |
| UserManagerImpl.java | 9/23/2008 1:33 PM | 5,156 |
| GetBeanContext.java | 9/23/2008 1:33 PM | 1,247 |
| DisplayDecorator.java | 9/23/2008 1:33 PM | 3,010 |
| Helper.java | 9/23/2008 1:33 PM | 18,992 |
| BatchLineVO.java | 9/11/2008 12:11 PM | 4,950 |
| BatchLnStructureVO.java | 9/11/2008 12:11 PM | 3,670 |
| ChildStructureVO.java | 9/1/2008 2:16 PM | 1,108 |
| ChildVO.java | 9/1/2008 2:16 PM | 1,089 |
| CnInfoVO.java | 9/1/2008 2:16 PM | 1,425 |
| CnSearchVO.java | 9/11/2008 12:11 PM | 3,432 |
| CnVO.java | 9/11/2008 12:11 PM | 3,885 |
| CompanyVO.java | 9/1/2008 2:16 PM | 3,482 |
| DetailCdxmlVO.java | 9/11/2008 12:11 PM | 1,579 |
| DetailPatentVO.java | 9/1/2008 2:16 PM | 1,145 |
| EnumerationVO.java | 9/11/2008 12:11 PM | 6,418 |
| EnumInfoVO.java | 9/11/2008 12:11 PM | 8,067 |
| FileUploadBean.java | 9/1/2008 2:16 PM | 520 |
| FilterVO.java | 9/1/2008 2:16 PM | 1,164 |
| InvoiceLineVO.java | 9/11/2008 12:11 PM | 2,992 |
| InvoiceVO.java | 9/1/2008 2:16 PM | 946 |
| KeywordVO.java | 9/11/2008 12:11 PM | 1,070 |
| ManageUserVO.java | 9/1/2008 2:16 PM | 3,279 |
| ManageVO.java | 9/1/2008 2:16 PM | 1,040 |
| PatentInfoVO.java | 9/11/2008 12:11 PM | 2,995 |
| PatentSearchVO.java | 9/1/2008 2:16 PM | 3,082 |
| PatentVO.java | 9/1/2008 2:16 PM | 3,055 |
| PreviousBatchVO.java | 9/4/2008 6:36 PM | 729 |
| ReportPatentVO.java | 9/1/2008 2:16 PM | 11,758 |
| ReportStructureVO.java | 9/1/2008 2:16 PM | 1,195 |
| ShortCutVO.java | 9/11/2008 12:11 PM | 1,112 |
| StructureCDXMLVO.java | 9/11/2008 12:11 PM | 2,421 |
| StructureInfoVO.java | 9/11/2008 12:11 PM | 1,515 |
| SuperAtomVO.java | 9/1/2008 2:16 PM | 4,267 |
| SupportVO.java | 9/1/2008 2:16 PM | 5,233 |
| UserCredentialVO.java | 9/11/2008 12:11 PM | 1,437 |
| UserIdentVO.java | 9/1/2008 2:16 PM | 1,367 |
| UserVO.java | 9/1/2008 2:16 PM | 6,104 |
| ValidationImportVO.java | 9/1/2008 2:16 PM | 1,148 |
| Version.java | 9/18/2008 11:32 ... | 789 |
| beans.xml | 9/25/2008 5:53 PM | 718 |
| ClientSOAPWS.java | 9/11/2008 12:12 PM | 2,696 |
| ClientSOAPWSImpl.java | 9/25/2008 5:53 PM | 28,248 |
| ClientWS.java | 9/23/2008 1:33 PM | 23,025 |
| ClientWSImpl.java | 9/23/2008 1:33 PM | 160,227 |
| EncryptPassword.java | 9/23/2008 1:33 PM | 1,781 |
| ImageCacheManager.java | 9/11/2008 12:12 PM | 673 |
| ImageCacheManagerImpl.java | 9/23/2008 1:33 PM | 8,964 |
| draw.properties | 9/1/2008 10:53 AM | 38 |
| messages.properties | 9/18/2008 11:38 ... | 13,007 |
| versionWeb.properties | 9/18/2008 11:39 ... | 13 |
| arrow_down.gif | 4/21/2008 4:00 PM | 847 |
| arrow_left.gif | 4/21/2008 4:00 PM | 852 |
| arrow_right.gif | 4/21/2008 4:00 PM | 853 |
| calendar.jpg | 4/21/2008 4:00 PM | 2,942 |
| l_cancel.gif | 4/21/2008 4:00 PM | 873 |
| operation_In_progress.gif | 6/5/2008 7:20 PM | 1,671 |
| private1_1x1.png | 5/26/2008 2:22 PM | 155,677 |
| private1_1x1_1x1.png | 5/26/2008 2:22 PM | 20,601 |
| private1_1x1_2x1.png | 5/26/2008 2:22 PM | 250 |
| private1_1x1_2x2.png | 5/26/2008 2:22 PM | 155 |
| private1_1x1_2x3.png | 5/26/2008 2:22 PM | 2,215 |
| private1_1x1_2x4.png | 5/26/2008 2:22 PM | 5,152 |
| private1_1x1_2x5.png | 5/26/2008 2:22 PM | 2,881 |
| private1_1x1_2x6.png | 5/26/2008 2:22 PM | 4,277 |
| private1_1x1_2x7.png | 5/26/2008 2:22 PM | 3,320 |
| private1_1x1_2x8.png | 5/26/2008 2:22 PM | 525 |
| private1_1x1_2x9.png | 5/26/2008 2:22 PM | 269 |
| private1_1x1_3x1.png | 5/26/2008 2:22 PM | 561 |
| private1_1x1_3x2.png | 5/26/2008 2:22 PM | 92,963 |
| private1_1x1_3x3.png | 5/26/2008 2:22 PM | 19,024 |
| private1_1x1_3x4.png | 5/26/2008 2:22 PM | 452 |
| private1_2x1.png | 5/26/2008 2:22 PM | 30,932 |
| private1_2x1_1x1.png | 5/26/2008 2:22 PM | 23,445 |
| private1_2x1_1x2.png | 5/26/2008 2:22 PM | 3,869 |
| private1_2x1_1x3.png | 5/26/2008 2:22 PM | 584 |
| private1_2x1_2x1.png | 5/26/2008 2:22 PM | 1,879 |
| private1_3x1.png | 5/26/2008 2:22 PM | 14,087 |
| private1_3x1_1x1.png | 5/26/2008 2:22 PM | 283 |
| private1_3x1_1x2.png | 5/26/2008 2:22 PM | 897 |
| private1_3x1_1x3.png | 5/26/2008 2:22 PM | 3,001 |
| private1_3x1_1x4.png | 5/26/2008 2:22 PM | 295 |
| private1_3x1_2x1.jpg | 5/26/2008 2:22 PM | 712 |
| private1_3x1_2x2.png | 5/26/2008 2:22 PM | 7,586 |
| private1_3x1_2x3.jpg | 5/26/2008 2:22 PM | 2,136 |
| private1_3x1_2x4.png | 5/26/2008 2:22 PM | 328 |
| Thumbs.db | 4/21/2008 4:00 PM | 7,168 |
| index.jsp | 4/3/2008 6:30 PM | 106 |
| createEnumeration.jsp | 9/21/2008 11:06 ... | 7,788 |
| listPatentsEnumeration.jsp | 9/30/2008 6:14 PM | 4,761 |
| listStructuresEnumeration.jsp | 9/30/2008 6:14 PM | 5,365 |
| reportPatentsEnumeration.jsp | 9/30/2008 6:14 PM | 6,568 |
| reportStructuresEnumeration.jsp | 9/30/2008 6:14 PM | 4,948 |
| error.jsp | 9/18/2008 11:33 ... | 469 |
| error_login.jsp | 7/9/2008 4:11 PM | 1,402 |
| header.jsp | 6/24/2008 3:51 PM | 229 |
| importTools.jsp | 9/23/2008 1:33 PM | 3,391 |
| invoiceList.jsp | 7/2/2008 4:12 AM | 1,216 |
| listAllInvoices.jsp | 7/15/2008 4:58 PM | 1,223 |
| viewInvoiceDetail.jsp | 7/15/2008 4:10 PM | 1,671 |
| viewInvoiceDetailAdmin.jsp | 7/15/2008 4:58 PM | 1,686 |
| createKeyword.jsp | 9/23/2008 1:33 PM | 826 |
| listKeywords.jsp | 9/23/2008 1:33 PM | 999 |
| layout.jsp | 7/8/2008 9:24 PM | 816 |
| layout-body.jsp | 6/2/2008 5:04 PM | 10 |
| layout-error.jsp | 7/2/2008 4:12 AM | 246 |
| layout-footer.jsp | 9/26/2008 10:35 ... | 1,828 |
| layout-header.jsp | 9/23/2008 1:33 PM | 1,325 |
| layout-help.jsp | 7/8/2008 10:07 PM | 558 |
| layout-help-text.jsp | 7/2/2008 4:12 AM | 268 |
| layout-menu.jsp | 9/23/2008 1:33 PM | 10,666 |
| layout-success.jsp | 7/2/2008 4:12 AM | 264 |
| login.jsp | 9/4/2008 6:41 PM | 2,042 |
| maintenance.jsp | 9/4/2008 6:40 PM | 416 |
| datailCn.jsp | 8/21/2008 6:30 PM | 793 |
| detailPatent.jsp | 9/1/2008 10:52 AM | 4,310 |
| listPatent.jsp | 7/2/2008 4:12 AM | 1,354 |
| registeredPage.jsp | 4/21/2008 10:51 ... | 251 |
| sendMaiToReceivePassword.jsp | 4/3/2008 7:02 PM | 795 |
| createAdminCompany.jsp | 8/6/2008 12:17 PM | 3,133 |
| createAdminUserProfile.jsp | 8/6/2008 12:17 PM | 6,173 |
| createSupport.jsp | 8/27/2008 6:09 PM | 2,313 |
| detailAdminCompany.jsp | 8/6/2008 12:17 PM | 4,556 |
| detailAdminUserProfile.jsp | 8/6/2008 12:17 PM | 8,177 |
| detailSupportRequest.jsp | 8/29/2008 10:35 ... | 4,645 |
| detailSupportRequestAdmin.jsp | 8/29/2008 10:35 ... | 4,666 |
| detailUserProfile.jsp | 7/18/2008 5:53 PM | 4,159 |
| listAllcompanies.jsp | 8/4/2008 6:16 PM | 1,400 |
| listAllEnumeration.jsp | 9/4/2008 6:41 PM | 5,944 |
| listAllSupport.jsp | 7/15/2008 7:18 PM | 1,604 |
| listAllUsersProfile.jsp | 7/18/2008 5:53 PM | 1,366 |
| listSupport.jsp | 7/2/2008 4:12 AM | 1,596 |
| myCompany.jsp | 7/2/2008 4:12 AM | 37,956 |
| reportEnumeration.jsp | 8/21/2008 6:30 PM | 5,393 |
| userProfile.jsp | 8/6/2008 12:17 PM | 5,086 |
| detailChildStructure.jsp | 7/2/2008 4:12 AM | 462 |
| detailStructures.jsp | 9/23/2008 1:33 PM | 3,048 |
| listStructures.jsp | 9/23/2008 1:33 PM | 2,661 |
| detailSuperAtom.jsp | 9/23/2008 1:33 PM | 1,506 |
| listSuperAtoms.jsp | 9/23/2008 1:33 PM | 5,079 |
| manageSuperAtom.jsp | 9/23/2008 1:33 PM | 3,155 |
| superAtom.jsp | 9/23/2008 1:33 PM | 2,204 |
| validateSuperAtom.jsp | 9/23/2008 1:33 PM | 530 |
| underConstruction.jsp | 7/2/2008 4:12 AM | 532 |
| actions.js | 9/1/2008 10:54 AM | 4,111 |
| calendar.js | 4/24/2008 11:17 ... | 49,237 |
| calendar-setup.js | 4/24/2008 11:17 ... | 8,853 |
| calendar-af.js | 4/24/2008 11:18 ... | 1,011 |
| calendar-al.js | 4/24/2008 11:18 ... | 2,135 |
| calendar-bg.js | 4/24/2008 11:18 ... | 3,723 |
| calendar-big5.js | 4/24/2008 11:18 ... | 3,290 |
| calendar-big5-utf8.js | 4/24/2008 11:18 ... | 3,525 |
| calendar-br.js | 4/24/2008 11:18 ... | 3,706 |
| calendar-ca.js | 4/24/2008 11:18 ... | 3,597 |
| calendar-cs-utf8.js | 4/24/2008 11:18 ... | 2,824 |
| calendar-cs-win.js | 4/24/2008 11:18 ... | 2,705 |
| calendar-da.js | 4/24/2008 11:18 ... | 3,500 |
| calendar-de.js | 4/24/2008 11:18 ... | 3,863 |
| calendar-du.js | 4/24/2008 11:18 ... | 1,143 |
| calendar-el.js | 4/24/2008 11:18 ... | 3,241 |
| calendar-en.js | 4/24/2008 11:18 ... | 3,600 |
| calendar-es.js | 4/24/2008 11:18 ... | 3,917 |
| calendar-fi.js | 4/24/2008 11:18 ... | 2,782 |
| calendar-fr.js | 4/24/2008 11:18 ... | 3,743 |
| calendar-he-utf8.js | 4/24/2008 11:18 ... | 3,919 |
| calendar-hr.js | 4/24/2008 11:18 ... | 3,088 |
| calendar-hr-utf8.js | 4/24/2008 11:18 ... | 1,553 |
| calendar-hu.js | 4/24/2008 11:18 ... | 3,603 |
| calendar-it.js | 4/24/2008 11:18 ... | 3,633 |
| calendar-jp.js | 4/24/2008 11:18 ... | 913 |
| calendar-ko.js | 4/24/2008 11:18 ... | 3,256 |
| calendar-ko-utf8.js | 4/24/2008 11:18 ... | 3,568 |
| calendar-lt.js | 4/24/2008 11:18 ... | 3,400 |
| calendar-lt-utf8.js | 4/24/2008 11:18 ... | 3,432 |
| calendar-lv.js | 4/24/2008 11:18 ... | 3,603 |
| calendar-nl.js | 4/24/2008 11:18 ... | 2,234 |
| calendar-no.js | 4/24/2008 11:18 ... | 3,178 |
| calendar-pl.js | 4/24/2008 11:18 ... | 2,414 |
| calendar-pl-utf8.js | 4/24/2008 11:18 ... | 2,635 |
| calendar-pt.js | 4/24/2008 11:18 ... | 3,526 |
| calendar-ro.js | 4/24/2008 11:18 ... | 2,058 |
| calendar-ru.js | 4/24/2008 11:18 ... | 4,357 |
| calendar-ru_win_.js | 4/24/2008 11:18 ... | 3,643 |
| calendar-si.js | 4/24/2008 11:18 ... | 2,684 |
| calendar-sk.js | 4/24/2008 11:18 ... | 2,661 |
| calendar-sp.js | 4/24/2008 11:18 ... | 3,015 |
| calendar-sv.js | 4/24/2008 11:18 ... | 3,205 |
| calendar-tr.js | 4/24/2008 11:18 ... | 1,736 |
| calendar-zh.js | 4/24/2008 11:18 ... | 3,082 |
| cn_utf8.js | 4/24/2008 11:18 ... | 4,630 |
| calendar.css | 4/21/2008 4:00 PM | 2,011 |
| calendar-win2k-cold-1.css | 4/24/2008 11:18 ... | 5,782 |
| decript.css | 6/17/2008 5:54 PM | 682 |
| displaytag.css | 6/23/2008 4:35 PM | 1,699 |
| test.jsp | 5/20/2008 4:13 PM | 355 |
| applicationContext.xml | 3/20/2008 8:33 PM | 381 |
| c.tld | 3/20/2008 8:33 PM | 15,999 |
| decript-Web-servlet.xml | 9/23/2008 1:33 PM | 11,800 |
| web.xml | 9/23/2008 1:33 PM | 5,118 |
| TestGenerique.java | 6/12/2008 5:57 PM | 7,237 |
| TestImageCacheManagerImpl.java | 6/27/2008 12:51 PM | 4,038 |
| TestTransWS.java | 7/3/2008 4:05 PM | 14,155 |
| TestWs.java | 6/30/2008 10:48 ... | 100,825 |
| web-assembly.xml | 3/26/2008 8:21 PM | 519 |
| .classpath | 9/18/2008 11:37 ... | 7,965 |
| .project | 4/8/2008 11:36 AM | 297 |
| org.eclipse.jdt.apt.core.prefs | 1/17/2008 3:52 PM | 183 |
| arg.eclipse.jdt.core.prefs | 9/18/2008 11:37 ... | 209 |
| org.eclipse.wst.validation.prefs | 1/17/2008 3:52 PM | 1,803 |
| pom.xml | 9/19/2008 3:14 PM | 5,730 |
| log4j.xml | 4/21/2008 6:58 PM | 2,966 |
| AuthAddRoleToUserEndpoint.java | 9/23/2008 1:28 PM | 3,623 |
| AuthCreateUserEndpoint.java | 9/23/2008 1:28 PM | 3,578 |
| AuthEndpoint.java | 9/1/2008 12:15 PM | 1,599 |
| AuthGetAllRolesEndpoint.java | 9/23/2008 1:28 PM | 3,885 |
| AuthGetUserIdentEndpoint.java | 9/23/2008 1:28 PM | 3,939 |
| AuthGetUserRolesEndpoint.java | 9/23/2008 1:28 PM | 3,995 |
| AuthLoginEndpoint.java | 9/23/2008 1:28 PM | 3,560 |
| AuthLogoutEndpoint.java | 9123/2008 1:28 PM | 3,228 |
| AuthRemoveRoleFromUserEndpoint.java | 9/23/2008 1:28 PM | 3,857 |
| AuthRemoveUserEndpoint.java | 9/23/2008 1:28 PM | 3,414 |
| AuthUpdateRoleToUserEndpoint.java | 9/23/2008 1:28 PM | 3,742 |
| AuthUpdateUserEndpoint.java | 9/23/2008 1:28 PM | 3,570 |
| DrawEndpoint.java | 9/1/2008 12:15 PM | 1,660 |
| DrawInstanceStructureEndpoint.java | 9/23/2008 1:28 PM | 7,830 |
| EnumBatchByUserEndpoint.java | 9/23/2008 1:28 PM | 7,395 |
| EnumerationBatchEndpoint.java | 9/23/2008 1:28 PM | 6,303 |
| EnumerationGetPreviousBatchEndpoint.j... | 9/18/2008 10:47 ... | 4,629 |
| EnumGetAllEnumerationsEndpoint.java | 9/23/2008 1:28 PM | 7,688 |
| EnumGetBatchHierarchybyAdminEndpoin... | 9/23/2008 1:28 PM | 7,403 |
| EnumGetBatchHierarchybyUserEndpoint... | 9/23/2008 1:28 PM | 6,957 |
| EnumGetBatchStructureHierarchybyUser... | 9/23/2008 1:28 PM | 7,882 |
| EnumGetListBatchStructureByUserEndpo... | 9/23/2008 1:28 PM | 7,531 |
| EnumReportPatentEnumByBatchEndpoin... | 9/23/2008 1:28 PM | 9,259 |
| EnumReportStructureEnumByBatchEndp... | 9/23/2008 1:28 PM | 9,809 |
| GetVersionEndPoint.java | 9/18/2008 10:47 ... | 4,136 |
| PayAllListInvoicesEndpoint.java | 9/23/2008 1:28 PM | 5,295 |
| PayDetailInvoiceByUserEndpoint.java | 9/23/2008 1:28 PM | 5,723 |
| PayListInvoiceByUserEndpoint.java | 9/23/2008 1:28 PM | 5,433 |
| SearchAllKeywordAndSaKeywordEndpoi... | 9/23/2008 1:28 PM | 5,820 |
| SearchCNByPatentEndpoint.java | 9/23/2008 1:28 PM | 7,278 |
| SearchDetailCDXMLEndpoint.java | 9/23/2008 1:28 PM | 5,612 |
| SearchDetailCNEndpoint.java | 9/23/2008 1:28 PM | 5,543 |
| SearchDetailSuperAtomEnpoint.java | 9/23/2008 1:28 PM | 6,012 |
| SearchEndpoint.java | 9/23/2008 1:28 PM | 1,682 |
| SearchGetNbInstancesStructureByIdEnd... | 9/18/2008 10:47 ... | 4,622 |
| SearchListCDXMLEndpoint.java | 9/23/2008 1:28 PM | 5,856 |
| SearchListChildCDXMLEndpoint.java | 9/23/2008 1:28 PM | 4,975 |
| SearchListCNEndpoint.java | 9/23/2008 1:28 PM | 5,777 |
| SearchListKeywordEndpoint.java | 9/23/2008 1:28 PM | 4,896 |
| SearchListPatentsEndpoint.java | 9/23/2008 1:28 PM | 6,000 |
| SearchListSuperAtomEndpoint.java | 9/23/2008 1:28 PM | 7,509 |
| AuthService.java | 9/18/2008 10:47 ... | 3,528 |
| AuthServiceImpl.java | 9/23/2008 1:28 PM | 8,679 |
| DrawService.java | 9/23/2008 1:28 PM | 853 |
| DrawServiceImpl.java | 9/18/2008 10:47 ... | 1,657 |
| EnumService.java | 9/18/2008 10:47 ... | 5,380 |
| EnumServiceImpl.java | 9/23/2008 1:28 PM | 7,536 |
| PayService.java | 9/18/2008 10:47 ... | 1,773 |
| PayServiceImpl.java | 9/18/2008 10:47 ... | 2,187 |
| SearchService.java | 9/18/2008 10:47 ... | 5,864 |
| SearchServiceImpl.java | 9/18/2008 10:47 ... | 16,480 |
| SessionService.java | 9/23/2008 1:28 PM | 9,180 |
| SessionServiceImpl.java | 9/18/2008 10:47 ... | 13,748 |
| StoreService.java | 9/23/2008 1:28 PM | 167 |
| StoreServiceImpl.java | 9/23/2008 1:28 PM | 191 |
| TransService.java | 9/18/2008 5:48 PM | 3,098 |
| TransServiceImpl.java | 9/18/2008 5:48 PM | 5,720 |
| SessionCreateCompanyByAdminEndpoin... | 9/18/2008 10:47 ... | 4,847 |
| SessionCreateKeywordEndPoint.java | 9/23/2008 1:28 PM | 3,926 |
| SessionCreateSupportRequestEndpoint... | 9/23/2008 1:28 PM | 4,365 |
| SessionCreateUserProfileEndpoint.java | 9/23/2008 1:28 PM | 5,267 |
| SessionDetailSupportRequestByUserEnd... | 9/23/2008 1:28 PM | 6,860 |
| SessionGetCompanyByAdminEndpoint.java | 9/23/2008 1:28 PM | 5,327 |
| SessionGetCompanyProfileEndpoint.java | 9/23/2008 1:28 PM | 5,621 |
| SessionGetListAllCompaniesEndpoint.java | 9/18/2008 10:47 ... | 5,854 |
| SessionGetListAllUserProfileEndpoint.java | 9/23/2008 1:28 PM | 6,051 |
| SessionGetListCompanyNamesEndpoint.j... | 9/23/2008 1:28 PM | 4,820 |
| SessionGetUserProfileByAdminEndpoint.j... | 9/23/2008 1:28 PM | 6,562 |
| SessionGetUserProfileEndpoint.java | 9/23/2008 1:28 PM | 5,820 |
| SessionListAllSupportRequestEndpoint.j... | 9/23/2008 1:28 PM | 7,410 |
| SessionListSupportRequestEndpoint.java | 9/23/2008 1:28 PM | 7,749 |
| SessionRemoveCompanyByAdminEndpoi... | 9/18/2008 10:47 ... | 3,778 |
| SessionRemoveUserProfileByAdminEndp... | 9/18/2008 10:47 ... | 3,944 |
| SessionSuppportRequestResponseEndp... | 9/23/2008 1:28 PM | 6,493 |
| SessionUpdateCompanyByAdminEndpoin... | 9/23/2008 1:28 PM | 4,856 |
| SessionUpdateCompanyProfileEndpoint.j... | 9/23/2008 1:28 PM | 6,536 |
| SessionUpdateStatusSuperAtomEndpoin... | 9/23/2008 1:28 PM | 4,161 |
| SessionUpdateSuperAtomEndpoint.java | 9/23/2008 1:28 PM | 5,146 |
| SessionUpdateUserProfileByAdminEndpo... | 9/23/2008 1:28 PM | 7,360 |
| SessionUpdateUserProfileEndpoint.java | 9/23/2008 1:28 PM | 7,100 |
| StoreEndpoint.java | 9/23/2008 1:28 PM | 1,677 |
| TransGetBatchReportPDFEndpoint.java | 9/23/2008 1:28 PM | 7,454 |
| TransGetGlobalSDFFilesEndpoint.java | 9/23/2008 1:28 PM | 7,050 |
| TransGetSDFFileEndpoint.java | 9/23/2008 1:28 PM | 9,427 |
| TransImportEndpoint.java | 9/23/2008 1:28 PM | 10,947 |
| WebServiceException.java | 9/18/2008 10:48 ... | 364 |
| versionWs.properties | 9/18/2008 11:04 ... | 13 |
| ws-auth-1.0.jar | 9/18/2008 11:03 ... | 236,442 |
| ws-draw-1.0.jar | 8/12/2008 5:09 PM | 29,897 |
| ws-enum-1.0.jar | 9/8/2008 11:49 AM | 304,366 |
| ws-pay-1.0.jar | 8/12/2008 5:09 PM | 84,140 |
| ws-search-1.0.jar | 8/12/2008 5:09 PM | 340,451 |
| ws-session-1.0.jar | 9/18/2008 11:03 ... | 500,481 |
| ws-trans-1.0.jar | 8/12/2008 5:09 PM | 98,334 |
| auth.wsdl.xml | 9/18/2008 11:03 ... | 18,604 |
| draw.wsdl.xml | 7/23/2008 4:51 PM | 2,812 |
| enum.wsdl.xml | 9/12/2008 11:02 ... | 26,605 |
| pay.wsdl.xml | 7/23/2008 4:51 PM | 6,978 |
| search.wsdl.xml | 7/23/2008 4:51 PM | 24,993 |
| session.wsdl.xml | 9/18/2008 11:03 ... | 42,384 |
| trans.wsdl.xml | 7/23/2008 4:51 PM | 7,912 |
| auth.xsd | 9/18/2008 10:50 ... | 8,179 |
| draw.xsd | 6/30/2008 10:49 ... | 1,330 |
| enum.xsd | 9/4/2008 6:36 PM | 15,974 |
| pay.xsd | 6/30/2008 10:49 ... | 3,649 |
| search.xsd | 7/23/2008 2:08 AM | 14,551 |
| securityPolicy.xml | 9/12/2008 11:03 ... | 342 |
| session.xsd | 8/27/2008 12:36 PM | 21,641 |
| spring-ws-servlet.xml | 9/18/2008 10:50 ... | 39,582 |
| trans.xsd | 7/3/2008 9:41 PM | 3,725 |
| web.xml | 1/17/2008 3:52 PM | 664 |
| beans.xml | 5/5/2008 3:13 PM | 715 |
| DigestProcessingFilterTests.java | 5/5/2008 3:13 PM | 21,552 |
| test.java | 5/29/2008 4:16 PM | 8,333 |
| TestCDKFileRead.java | 5/23/2008 12:52 PM | 2,673 |
| TestClientWSImpl.java | 6/13/2008 12:36 PM | 11,558 |
| TestDrawMol.java | 5/23/2008 11:41 ... | 1,723 |
| TestDrawWs.java | 5/23/2008 12:52 PM | 1,233 |
| TestEncryption.java | 5/7/2008 8:42 PM | 5,893 |
| TestSoapWS.java | 5/7/2008 8:42 PM | 14,046 |
| buildandclean.bat | 10/14/2008 | 3,496 |
| buildandclean.sh | 10/15/2008 | 2,270 |

1. A process for rendering general chemical structure descriptions of compositions of matter enumerable, comprising the following steps:
generating and storing Markush structure core topology descriptors;
generating and storing Markush structure substituent fragment topology descriptors;
generating and storing enumeration rules by creating associations between Markush structure core topology descriptors, Markush structure substituent fragment topology descriptors and attachment points in Markush structure core topology descriptors for said Markush structure substituent fragment topology descriptors;
enumerating individual species in accordance with said enumeration rules; and
displaying information that characterizes the enumerated species.

2. The method of claim 1 wherein the step of generating and storing Markush structure topology descriptors comprises:
providing Markush structure related search results from a user query to a Markus structure database containing Markush structure topology information for said search results;
rendering Markush Structure topology information from said Markush structure database into enumerable Markush Structure topology descriptors; and
storing said enumerable Markush structure topology descriptors into an intermittent database.

3. The method of claim 2, wherein said Markus structure database comprises at least one of a MMS or Marpat Markush structure database.

4. The method of claim 1 wherein the step of generating and storing substituent fragment topology descriptors comprises:
obtaining terminology of substituent definitions;
rendering said terminology into enumerable substituent fragment topology descriptors by replacing said substituent definitions with substituent fragment topology descriptors comprising enumerable structure fragments; and
storing said enumerable substituent fragment topology descriptors in a database.

5. The method of claim 4, wherein said terminology of substituent definitions is obtained from one of the following sources:
a Markush structure database,
the claims of patent-related documents,
user-created renderings of general chemical structure descriptions.

6. The method of claim 1 wherein the step of generating and storing enumeration rules comprises:
rendering general chemical structure topology descriptions in enumeration-readied form;
generating enumeration rules by creating associations between said enumerable Markush structure topology descriptors and Markush structure text information; and
storing said enumerable Markush structure topology descriptors and said enumeration rules in a database.

7. The method of claim 6 wherein said step of rendering general chemical structure topology descriptions is performed by using commercially available software enabling the drawing of general chemical structure representations.

8. The method of claim 6 wherein said step of rendering general chemical structure topology descriptions is performed by importing Markush structure topology information from a Markush structure database and translating said imported Markush structure topology information into enumeration readied Markush structure topology descriptors.

9. The method of claim 8 wherein said imported Markush structure topology information is translated into enumeration readied Markush structure topology descriptors using one of machine aided translation processes or user guided software enabling the rendering of general chemical structure representations or machine aided processes enabling the translation of images of general chemical structure representations into machine readable forms.

10. The method of claim 6 wherein the step of creating associations between said enumeration ready topology descriptors and Markush structure text information is performed by creating user-guided associations between specific Markush structure core topology descriptors and by creating user-guided associations between attachment points in said Markush structure core topology descriptors and the topology descriptors of substituent groupings.

11. A process for enumerating general chemical structure descriptions of compositions of matter, comprising the following steps:
enumerating individual species by attaching selected substituent fragment topology descriptors to a selected Markush structure core descriptors, in accordance with enumeration rules,
assigning an identifier to each such species;
storing said identifier in a database; and
displaying information that characterizes species whose identifiers are retrieved from the database.

12. The method of claim 11 wherein the step of enumerating individual species includes:
importing enumeration readied Markush structure core topology descriptors into a Markush structure enumerator;
importing enumeration readied substituent structure fragment topology descriptors into the Markush structure enumerator;
importing of enumeration rules into the Markush structure enumerator;
attaching said enumeration readied substituent structure fragment topology descriptors to said enumeration readied Markush structure core topology descriptors, using a random selection of substituent groupings in manner defined by said enumeration rules, to enumerate said species.

13. The method of claim 12, further including the steps of:
associating said identifiers with the enumeration rule information yielding the species, the topology descriptors defining the chemical structures and the information defining the origin of the Markush structure descriptors yielding the enumerated species; and
exporting of said associated information into an enumerated compound database.

14. The method of claim 13, further including the steps of:
creating chemical structure topology fingerprints of enumerated species in said enumerated compound database;
associating said structure topology fingerprints of a species and the identifier of said species and the enumeration rules yielding said species and the information defining the origin of the Markush structure pertaining to said species; and
storing said associated information in a database.

15. The method of claim 11, wherein said identifier comprises a name and a registration code.

16. A process for determining and comparing the content of general chemical structure descriptions of compositions of matter, comprising the following steps:
retrieving chemical structure fingerprints associated with individual enumerated species from a database;
measuring relative chemical structure fingerprint similarity between said species;
associating identifiers of said species with said fingerprint similarity measures; and
displaying said fingerprint similarity measures.

17. The method of claim 16, wherein said identifier comprises a name and a registration code.

18. The method of claim 4 further including the steps of creating superatom fragment libraries to effect the rendering of terminologies in substituent definitions of generic chemical structure descriptions into enumerable substituent fragment topology descriptors, by replacing said substituent definitions with substituent fragment topology descriptors comprising enumerable structure fragments.

19. The method of claim 18 further including steps for replacing said substituent definitions with fragment topology descriptors comprising enumerable structure fragments of amino-acids, proteins, DNA, RNA, carbohydrates or derivatives thereof.

20. The method of claim 1, further including the step of creating renderings of Markush structure topology descriptions from different documents for comparison of the same.

21. The method of claim 16 further including the step of calculating one or multiple molecular properties of said species; and storing said associated molecular property information in a database.

22. The method of claim 21 including steps for analyzing molecular property similarities between said species comprising steps for:
retrieving said chemical structure topology fingerprints;
retrieving said species molecular properties;
determining the similarity between said retrieved chemical structure topology fingerprints; and
determining the similarity between said molecular properties.

23. The method of claim 16, wherein the relative chemical structure fingerprint similarity is measured by using methods for chemical structure fingerprint profile comparison or methods for clustering said fingerprints of said species.

24. A process for rendering, determining and comparing the content of general chemical structure descriptions of compositions of matter, comprising the following steps:
generating and storing Markush structure core topology descriptors;
generating and storing Markush structure substituent fragment topology descriptors;
generating and storing enumeration rules by creating associations between Markush structure core topology descriptors, Markush structure substituent fragment topology descriptors and attachment points in Markush structure core topology descriptors for said Markush structure substituent fragment topology descriptors;
enumerating individual species by attaching selected ones of said substituent fragment topology descriptors to a selected one of said Markush structure core descriptors, in accordance with said enumeration rules,
assigning an identifier to each such species and storing such identifier;
assigning a chemical structure fingerprint to each such species, and storing the species chemical structure fingerprints;
measuring relative chemical structure fingerprint similarity between said species;
associating said identifiers of said species with said fingerprint similarity measures; and
displaying said fingerprint similarities measures.
